(19) United States
(12) Patent Application Publication
(10) Pub. No.: US 2025/0205929 A1
(43) Pub. Date: Jun. 26, 2025

(54) PREFORMS FOR FLAIR APPLICATIONS

(71) Applicant: Dispensing Technologies B.V., Helmond (NL)

(72) Inventors: Wilhelmus Johannes Joseph Maas, Someren (NL); Petrus Lambertus Wilhelmus Hurkmans, Someren (NL); Aaron Haleva, Oakhurst, NJ (US)

(21) Appl. No.: 18/935,539

(22) Filed: Nov. 3, 2024

Related U.S. Application Data
(63) Continuation of application No. 17/149,391, filed on Jan. 14, 2021, now Pat. No. 12,138,826.
Application No. 17/149,391 is a continuation of application No. 13/330,632, filed on Dec. 19, 2011, now Pat. No. 10,894,340.
(60) Provisional application No. 61/459,712, filed on Dec. 17, 2010.

(51) Int. Cl. B29B 11/14; B29B 11/04; B29C 49/00; B29C 49/06; B29C 65/00; B29C 65/06; B29C 65/08; B29C 65/48; B29C 65/60; B29K 23/00; B29K 67/00; B29L 9/00; B29L 31/00; B29L 31/56; B65D 1/02; B65D 41/04; B65D 41/06; B65D 49/02; B65D 77/06; B65D 83/00

(52) U.S. Cl. CPC B29B 11/14; B29C 49/0005; B29C 49/06; B65D 1/0246; B65D 41/0471; B65D 41/065; B65D 49/02; B65D 77/06; B65D 83/771; B29B 11/04; B29C 65/0672; B29C 65/08; B29C 65/48; B29C 65/606; B29C 66/12261; B29C 66/1284; B29C 66/12861; B29C 66/1312; B29C 66/21; B29C 66/542; B29C 66/545; B29C 66/71; B29C 2949/072; B29C 2949/073; B29C 2949/077; B29C 2949/0772; B29C 2949/0776; B29C 2949/0778; B29C 2949/078; B29C 2949/0781; B29C 2949/22; B29C 2949/3012; B29C 2949/3016; B29C 2949/302; B29C 2949/3026; B29C 2949/3028; B29C 2949/3034; B29C 2949/3064; B29C 2949/3078; B29C 2949/3086; B29K 2023/12; B29K 2067/003; B29L 2009/001; B29L 2031/565; B29L 2031/7282; B29L 2031/7506

(57) ABSTRACT

A preform made from two different materials that do not bond together by a bi-injection process, using the same mold, is presented. An outer layer of the preform can be first made, then an inner layer molded through a center hole in a bottom of the outer layer, and the two layers connected. Inner/outer preform materials can be different, such as PET/polyolefin or polyamide, or the same, such as PET/PET. To prevent mutual bonding during molding of the second layer, a non-stick coating may be sprayed onto a surface portion of the first layer prior to molding the second. In embodiments, manufacturing order can be either outer/inner, or inner/outer, and the non-stick coating sprayed on the inside/outside of the layer first molded.

### CROSS-REFERENCE TO RELATED APPLICATIONS

This application claims the benefit of U.S. Provisional Patent Application No. 61/459,712, entitled “IMPROVED PRE-FORMS FOR FLAIR APPLICATIONS,” and filed on Dec. 17, 2010.

### TECHNICAL FIELD

The present invention relates to blow molding and dispensing technologies, and in particular to novel pre-forms for use in Flair and Flair-type liquid delivery systems.

### BACKGROUND OF THE INVENTION

Flair technology, developed and marketed by assignee hereof, Dispensing Technologies, B.V., of Helmond, Netherlands, utilizes a “bag in a bag,” or inner container and outer container system for dispensing products such as liquids, for example. The two containers originate as plastic pre-forms, and are then blown to final size. Sometimes this two container, or two pre-form, system is known as a “bi-layer” container or pre-form, as the case may be. Thus, there is an inner pre-form and an outer pre-form, which, once blown to final size, become an inner container and an outer container. The inner and outer performs can, for example, be made from the same material, such as, for example, a polyolefin, or, for example, they can be made from different materials, such as, for example, PET and a polyolefin, such as, for example, polypropylene (“PP”).

Flair technology uses a displacement medium, such as air, for example, to maintain a certain pressure between the inner container and the outer container. This causes the inner container to shrink as the liquid provided inside it is dispensed, and thus precludes the need for the liquid to ever come into contact with the outside air or environment. The two Flair containers are joined at their tops and at the bottom, and there is a passageway for the displacement medium to enter, or to be pumped, between them. The creation and provision of these elements needs to be addressed during the creation of the pre-forms. When the inner and outer pre-forms are of the same material, or of different materials but having essentially equal molding temperatures, special care must be taken so that the two performs do not fuse along their interface and become bonded to one another.

Additionally, in some circumstances, the two preforms can be molded in novel and more efficient ways.

Various improved methods of molding pre-forms, as well as novel designs and variations for different contexts, are presented.

### SUMMARY OF THE INVENTION

Improved pre-forms for Flair and Flair-type applications are presented. In exemplary embodiments of the present invention, if two different materials which do not bond together are used to make a pre-form, then such a pre-form can be made by a bi-injection process, using the same mold. In such exemplary embodiments, first the outer pre-form can be fashioned, and then the inner pre-form can be molded through a center hole provided at the bottom of the outer pre-form. The two pre-forms are then connected to each other. The two materials can be different, such as PET and a polyolefin, or for example, they can even be the same, such as PET/PET, if steps are taken to prevent their bonding during the molding of the second pre-form layer. In such a process, a non-stick coating can be sprayed on the surface that will be between the pre-forms, where the second perform will touch the first one, and after such application, the second container can be molded, also in a 2C process. The order of manufacture can be either outer then inner, or inner then outer, in various exemplary embodiments. If outer then inner, the non-stick coating can be sprayed on the inside of the first molded outer perform, followed by molding of the inner preform. If the reverse, the non-stick coating is sprayed on the outside of the first molded inner perform, then followed by the molding of the outer perform. In exemplary embodiments of the present invention, The material from which the inner container is made, the degree of shrinkage it will experience relative to the outer container, and the concomitant maximum hot fill temperature it can thus support, can all be designed for a given application, use or range of uses.

### BRIEF DESCRIPTION OF THE DRAWINGS

It is noted that the U.S. patent or application file contains at least one drawing executed in color (not applicable for PCT application). Copies of this patent or patent application publication with color drawings will be provided by the U.S. Patent Office upon request and payment of the necessary fee.

FIG. 1 depicts an exemplary bi-layer bottle and preform without an airvalve provided in the containers, for appliances having an airvalve according to exemplary embodiments of the present invention;

FIG. 2 depicts an exemplary bi-layer bottle, with a secure connection between the bottle and an air tube according to exemplary embodiments of the present invention;

FIG. 3 depicts perspective and longitudinal cross-section views of an exemplary bi-layer bottle, provided with an air pressure release mechanism according to an exemplary embodiment of the present invention;

FIG. 3A-A illustrates an exemplary preform without an air valve, formed using an overmolding process, according to an exemplary embodiment of the present invention;

FIG. 3A-B illustrates a bottom view of the preform, with two cross sectional cut lines;

FIG. 3A-C illustrates a side view of the preform along the first cross-sectional cut line;

FIG. 3A-D illustrates an alternate side view, along the second cross-sectional cut line;

FIG. 3B-A illustrates the process of blowing a bottle from a preform according to an exemplary embodiment of the present invention;

FIG. 3B-B illustrates the process of FIG. 3B-A with the preform superimposed on the bottom of a full blown bottle;

FIG. 3C-A depicts various details of an exemplary bottle without an air valve according to an exemplary embodiment of the present invention;

FIG. 3C-B illustrates a first cross section of the exemplary bottle of FIG. 3C-A;

FIG. 3C-C illustrates a second cross section of the exemplary bottle of FIG. 3C-A;

FIG. 3C-D illustrates a third cross section of the exemplary bottle of FIG. 3C-A;

FIG. 3C-E illustrates a bottom view of the bottle of FIG. 3C-A, showing the three cross-sections;

FIGS. 3D-A, FIGS. 3D-B and FIGS. 3D-C are magnified details of the respective cross sections along the lines C-C, D-D and E-E as shown in FIGS. 3C-E;

FIG. 3E illustrates the process of separating the layers in a bottle formed from a preform according to an exemplary embodiment of the present invention;

FIG. 3F illustrates the push pin of the inside layer being contacted with a mating portion of an air supply device according to an exemplary embodiment of the present invention;

FIGS. 3G and 3H illustrate the initiation of layer separation by introducing positive pressure from the air supply device through the hole now created by the push pin; FIG. 3I illustrates how after the layers have been separated the air supply device can switch to an under pressure to cause the inner layer to follow the shape and contour of outer layer;

FIG. 3L shows the net result of the layer separation process according to an exemplary embodiment of the present invention;

FIG. 4 depicts exemplary inner and outer pre-forms for a PET/PET crimp neck type preform, where the pre-forms are spin welded at the top to connect them according to exemplary embodiments of the present invention;

FIGS. 4A and 4B illustrate the outside and inside layers, respectively, of a PET/PET preform for a standard Flair system according to an exemplary embodiment of the present invention;

FIG. 4C-A illustrates how the inside layer is assembled into the outside layer for the PET/PET preform of FIGS. 4A and 4B.

FIG. 4C-B shows a push down and spin welding process to connect the two layers;

FIG. 4C-C shows a melted area where the two layers are connected;

FIG. 4C-D shows detail of the view of FIG. 4C-C;

FIG. 4DA shows how the inside layer is connected to the outside layer by means of an ultrasonic deformation of its central pin according to an exemplary embodiment of the present invention;

FIG. 4D-B illustrates flattening of the central pin;

FIG. 4D-C shows a perspective view of the now joined preform layers;

FIG. 4E-A illustrates a one way valve used in connection with the PET/PET preform of FIG. 4;

FIG. 4E-B shows a bottom view of the one way valve;

FIG. 4E-C shows a side view thereof;

FIG. 4E-D shows a perspective top view thereof;

FIG. 4E-E shows an alternate view thereof, with several cross-sectional lines;

FIG. 4F illustrates several side cross-sectional views of the one way valve corresponding to the four cross-sectional lines in FIG. 4E-E;

FIG. 4G illustrates the connection of the one way valve of FIGS. 4E and 4F onto the PET/PET preform of FIGS. 4A and 4B according to an exemplary embodiment of the present invention;

FIG. 5 depicts steps in assembly of an exemplary bi-layer pre-form as connected to an appliance that has a built-in air-valve according to exemplary embodiments of the present invention;

FIG. 5A shows magnified details of an exemplary preform with and without an exemplary power connector;

FIGS. 6 and 7 respectively depict depict two stages in the manufacture of a PET/PP pre-form according to exemplary embodiments of the present invention;

FIG. 6A illustrates detail of a first step of 2C molding a PET/PP preform for use in standard Flair applications with hooks to avoid turning according to an exemplary embodiment of the present invention;

FIG. 7A illustrates detail of a second step in the 2C molding of the PET/PEP small standard bayonet preform;

FIG. 7B illustrates methods and geometries to obtain a tight seal connection between the inner and outer layers of the preform of FIGS. 6A and 7A

FIGS. 8-10 depict two stages in the manufacture of a PET/PET pre-form according to exemplary embodiments of the present invention where the outside layer is molded first;

FIG. 8A illustrates a first step in molding the outside layer of a standard Flair 2C PET/PEP preform with hooks to avoid turning according to an exemplary embodiment of the present invention;

FIGS. 9 and 9A illustrate depositing a non-stick coating between the layers;

FIG. 10A illustrates the second step of molding the inner layer of the standard Flair bayonet 2C PET/PEP preform;

FIGS. 11-14 depict two stages in the manufacture of a PET/PET pre-form according to alternate exemplary embodiments of the present invention where the inside layer is molded first and a non-stick coating deposited between the layers;

FIGS. 15 and 16 depict an exemplary pre-form with a bayonet neck finish, usable in “OpUs” type sprayers according to exemplary embodiments of the present invention;

FIG. 17 depicts an exemplary PET/PP pre-form with a crimp neck finish according to exemplary embodiments of the present invention;

FIG. 18 depicts various views of an exemplary pre-from with a crimp neck, with an air valve and a dip tube according to exemplary embodiments of the present invention;

FIG. 19 depicts how an exemplary pre-form can be blown into various bottle types, with exemplary dimensions provided for a flat type bottom, according to exemplary embodiments of the present invention;

FIGS. 20-22 depict an exemplary process for 2C molding a “Piston Flair” type PET/PET pre-form according to exemplary embodiments of the present invention;

FIGS. 23-25 depict an alternate exemplary process for 2C molding a “Piston Flair” Bayonet type PET/PET pre-form according to exemplary embodiments of the present invention;

FIGS. 26A-A illustrates a pre-form with a one way valve according to an exemplary embodiment of the present invention;

FIG. 26A-B is the pre-form of FIG. 26A-A, with an area of detail indicated;

FIG. 26A-C shows an upright side view of the pre-form of FIG. 26A-A;

FIG. 26A-D shows an upside-down view of the pre-form of FIG. 26A-A;

FIG. 26A-E shows a bottom view of the pre-form of FIG. 26A-A, with two cross-sectional lines drawn in;

FIG. 26B is a magnified view of the area of detail of FIG. 26A-B;

FIGS. 26C and 26D respectively illustrate an under pressure situation and an over pressure situation in the pre-form of FIG. 26A;

FIG. 26E illustrates the non-refill functionality of a bottle made from the pre-form of FIG. 26A;

FIGS. 26F through 26H illustrate details of attaching the one way valve to the bottom of the pre-form of FIG. 26A where a layer release button is used in the preform; and

FIGS. 27A and 27B illustrate a 3-lug bayonet snap-on neck finish according to exemplary embodiments of the present invention;

FIG. 27C is a top view showing various structures in the neck of FIGS. 27A and B;

FIGS. 27D and 27E show an alternate exemplary embodiment of the present invention with a 4-lug bayonet snap-on neck finish and details thereof;

FIG. 27F shows a top view showing the relationship of various structures of the 4-lug bayonet snap-on neck finish of FIG. 27D;

FIG. 27G illustrates details of a lead in for a snap-on hook on an exemplary lug of the 4-lug bayonet snap-on neck finish of FIG. 27D;

FIGS. 27H-A illustrates an exemplary 4-lug bayonet snap-on caps according to exemplary embodiments of the present invention;

FIG. 27H-B is a cross sectional view along a first cross-section line A-A as shown in FIG. 27H-A;

FIG. 27H-C is a bottom view of the cap of FIG. 27H-A;

FIG. 27H-D is a cross sectional view along a second cross-section line B-B as shown in FIG. 27H-C

FIG. 27I-A shows an alternate view of the cap of FIG. 27H-A;

FIG. 27I-B shows a top view of the cap of FIG. 27I-A;

FIG. 27I-C is a perspective bottom view of the cap of FIG. 27I-A;

FIG. 27I-D is a bottom view of the cap of FIG. 27I-A;

FIG. 27J-A illustrates attaching the four lug bayonet cap of FIGS. 27H and 27I onto a Hair type bottle provided with a four lug bayonet neck finish according to exemplary embodiments of the present invention;

FIG. 27J-B is a magnified cut away view of a vertical downward pushing step;

FIG. 27J-C is a magnified cut away view of a rotational (here clockwise) step;

FIGS. 27K, 27L and 27M are magnified views of each of the images respectively shown in FIGS. 27J-A, 27J-B and 27J-C for ease of illustration;

FIG. 27N-A illustrates attaching the 4-lug bayonet cap to a neck according to exemplary embodiments of the present invention;

FIG. 27N-B shows the cap as attached to the neck at an embellished lug;

FIG. 27O illustrates features of the “end rib” (on all four lugs) and “anti back off rib” (on two lugs), according to exemplary embodiments of the present invention;

FIG. 27P illustrates the four lug bayonet cap principle detailing the interlocking of the hooks of the cap with the lugs of the neck according to exemplary embodiments of the present invention;

FIGS. 27Q, 27R and 27S illustrate further details of the snap-on functionality;

FIG. 27Q shows lining up of a cap above an embellished lug, where four positions of the cap relative to the neck are possible;

FIG. 27R shows horizontal portions of embellished lugs with lead-in structures;

FIG. 27S shows a cap attaching to a neck using a snap-on function;

FIG. 27T illustrates an exemplary cap and bottle neck where removable snap-on has been completed, and FIG. 27U illustrates an exemplary cap and bottle neck where non-removable snap-on has been completed;

FIG. 28A shows an exemplary preform, rotating inside a heating oven so that it can be made ready to be blown into a bottle;

FIG. 28B depicts a fully blown bottle, and a detail of the bottom corners, for an exemplary perform according to exemplary embodiments of the present invention;

FIG. 28C depicts a comparison of plastification curves for two exemplary materials used, respectively, as the outer layer and inner layer of a perform, according to exemplary embodiments of the present invention; and

FIG. 28D depicts the comparison of FIG. 28C after modifying Material ‘B’ (inner layer) so that the plastification curves are aligned.

### DETAILED DESCRIPTION OF THE INVENTION

Pre-forms for various container within a container applications have an inner layer and an outer layer. Conventionally, these layers are separately molded, and then later brought together and attached by some means, often in a separate process, and often performed by the entity that blows the pre-forms to full size. This can be inefficient. It also means that the manufacture of the pre-forms does not create a finished product, and a further processing step is required to actually join the preforms so that they can be used. It is noted that for Flair and similar “bag in a bag” dispensing technologies, the inner container must be sealed to the outer container so that there is no leakage of any liquid from the inner container, and so that said liquid does not contact ambient air or any surroundings.

In exemplary embodiments of the present invention, if two different materials which do not bond together are used to make a pre-form, such as, for example, PET/PP, then such a pre-form can be made by a bi-injection molding process (also known as a “two component” or “2C” process, and so used herein), using the same mold. In such exemplary embodiments, the outer pre-form can first be fashioned, and then the inner pre-form can be molded through a center hole provided at or in the bottom of the outer pre-form. By virtue of the bi-injection molding, the two pre-forms are then connected to each other at the bottom and at the top. Such a bi-injection molding process is more efficient. Additionally, if a perform with both layers comprising the same material is desired, e.g., PET/PET, then the pre-form can also be made using a 2C process if proper steps are taken to prevent the bonding of the inner container to the outer container, such as, for example, application of a nonstick coating between injections, as described below.

Alternatively, the two performs can be separately molded, and then connected, by a variety of possible connection processes, including welding, crimping and the like. In all such processes, a finished pre-form, ready for blowing without additional processing steps results. Various such improved processes and features are next described with reference to the figures.

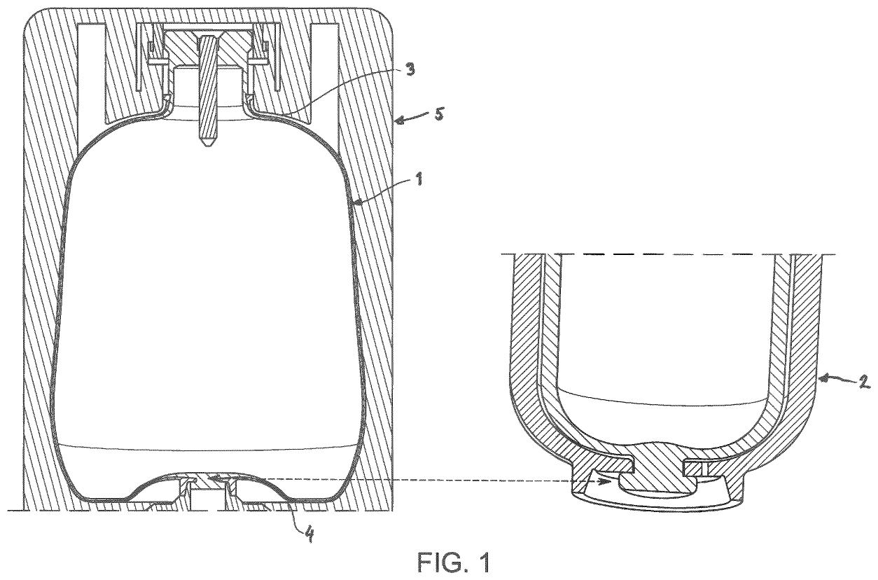

FIG. 1 depicts an exemplary bi-layer bottle 1 (left image) and pre-form 2 (right image) according to exemplary embodiments of the present invention. The bottle and preform do not contain an integrated air valve, as this can be provided in an appliance (referred to as “equipment” in the figure) to which the bottle is intended to be connected to. The bottle 1 can be clamped at the top 3 and bottom 4, and thus fully sealed within, a dispensing device 5.

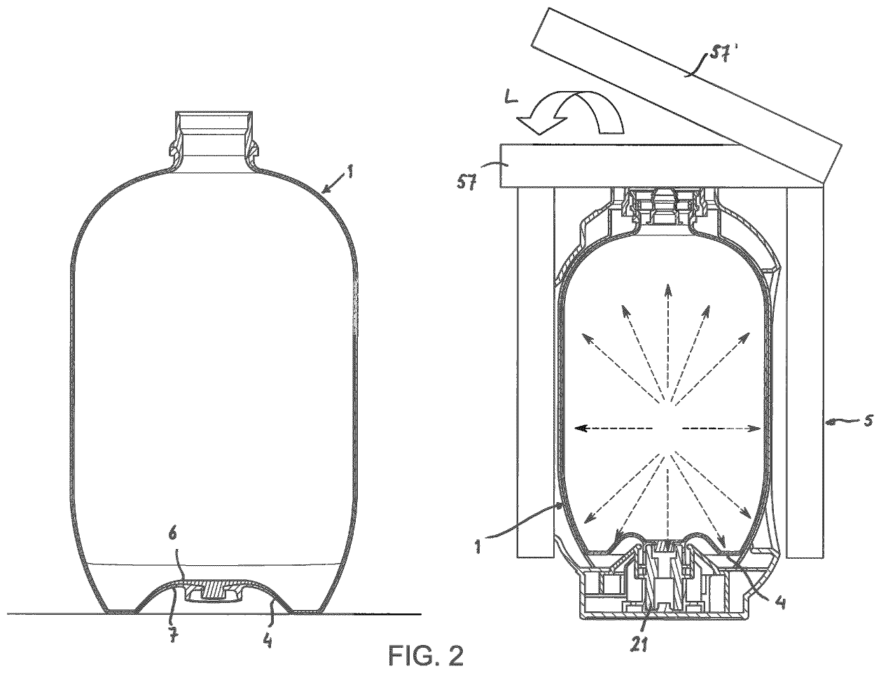

FIG. 2 depicts an exemplary bi-layer bottle 1 with a petaloid bottom 4 (such as is used in 2L soda bottles and the like) illustrating that the connection between the bottle 1 and an air tube 21 connected to the bottom 4 of the bottle 1 must be secure (see right image). The left image illustrates how the inner container 6 is welded to the outer container 7 at the bottom 4 of the bottle. Because there is a pressure maintained between the two layers of the bottle, once the appliance door 57 is opened on top (and thus no valve containing the liquid), if the pressure is not released the liquid L inside the inner bottle 6 can splash out. Thus, a mechanism is needed to release that pressure when removing the bottle 1, for example, to replace it. As noted, these bottles do not have an air connector, so this air pressure cannot simply be released by reverse pumping or opening the pump valve to the atmosphere. Referring back to FIG. 1, if there is no closed valve at the top 3 of the bottle 1 and the valves are in the appliance 5, then it is necessary that the air between the two layers 6, 7 of the bottle, as shown in FIG. 2, be released before the bottle 1 is taken out of the appliance 5, to avoid splashing of the liquid.

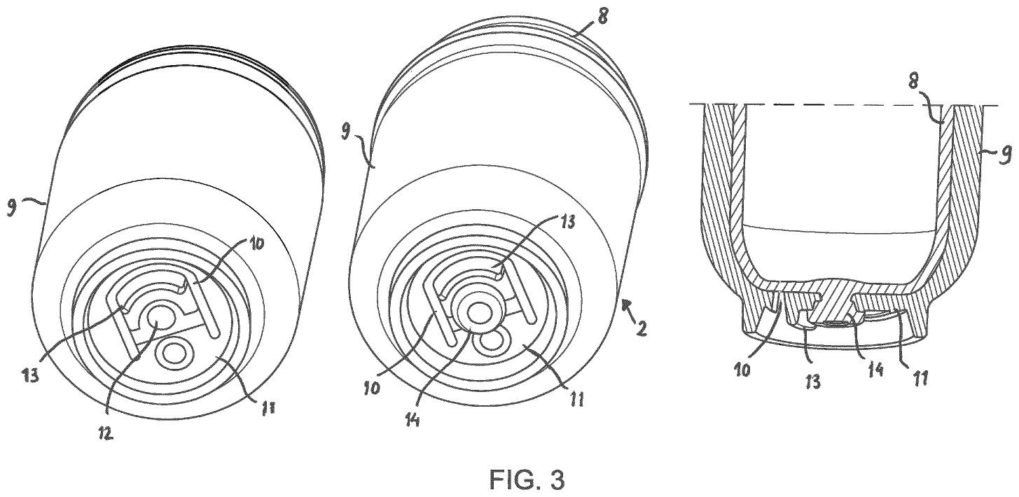

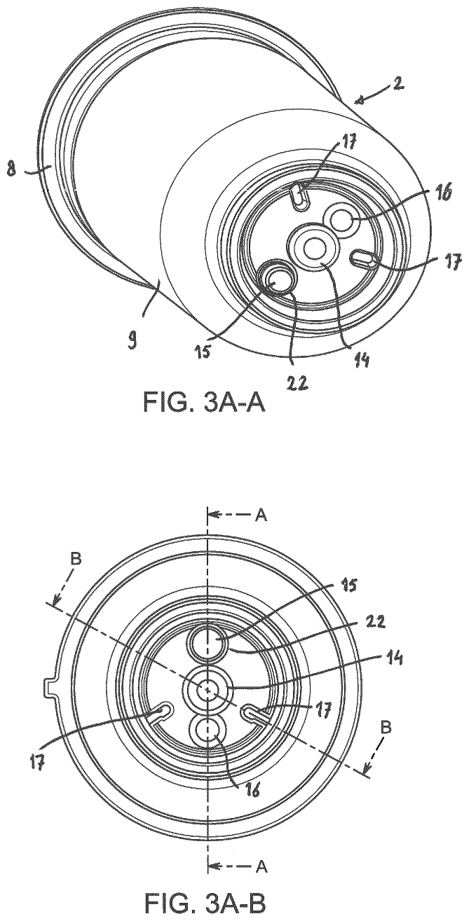

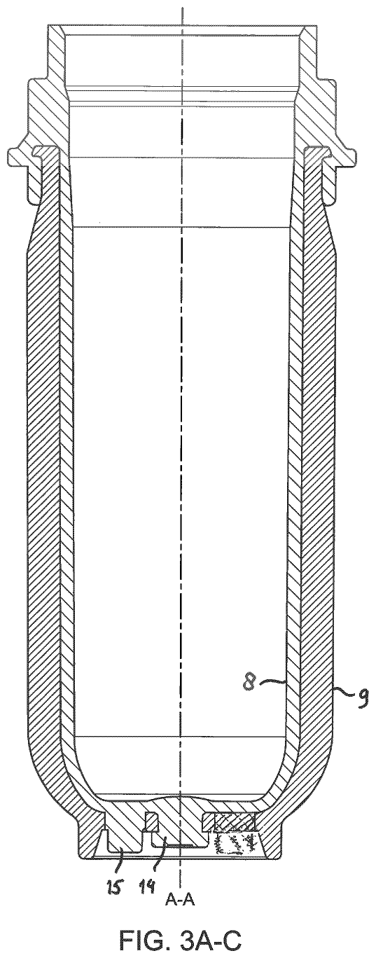

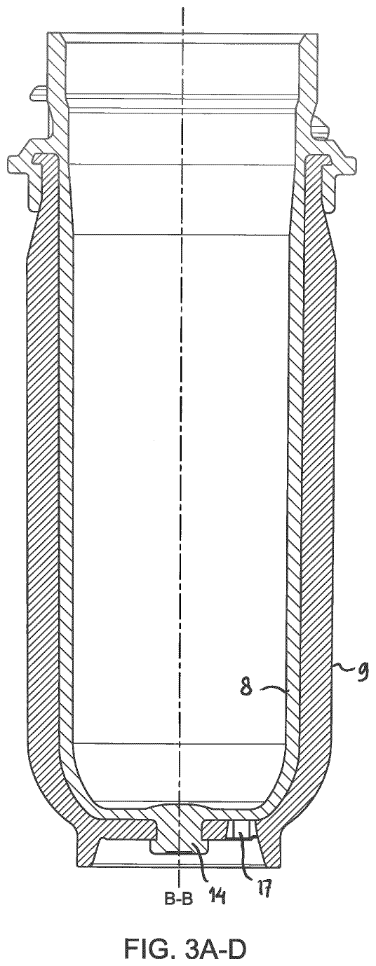

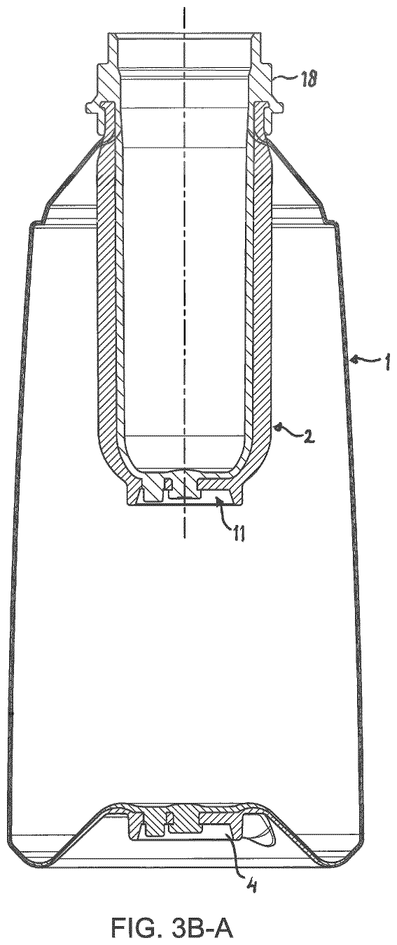

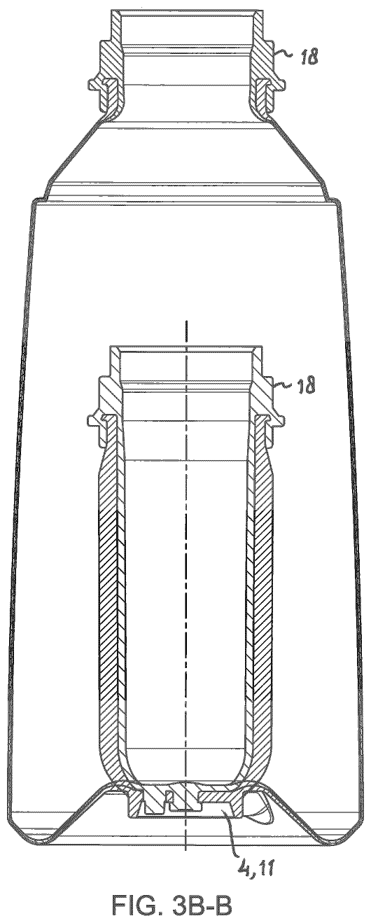

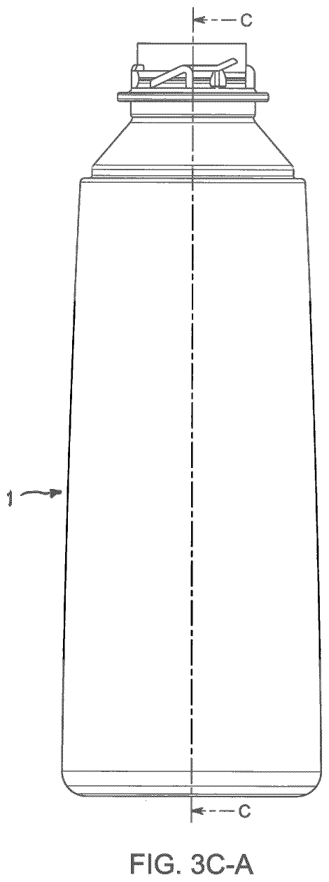

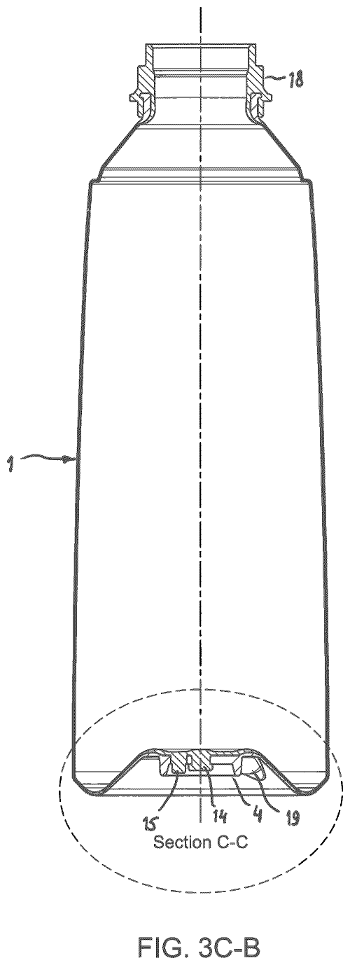

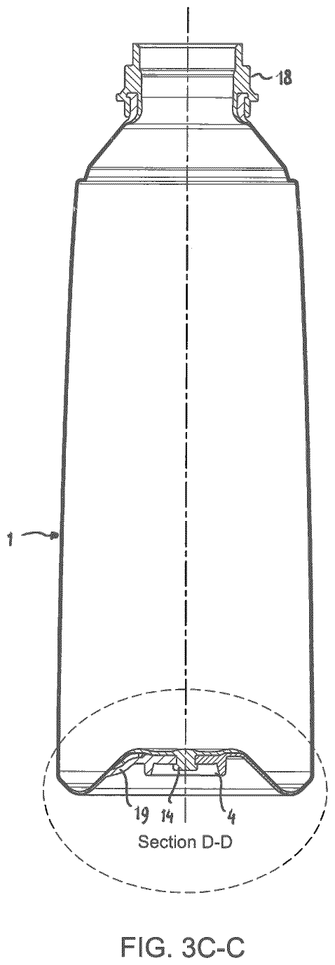

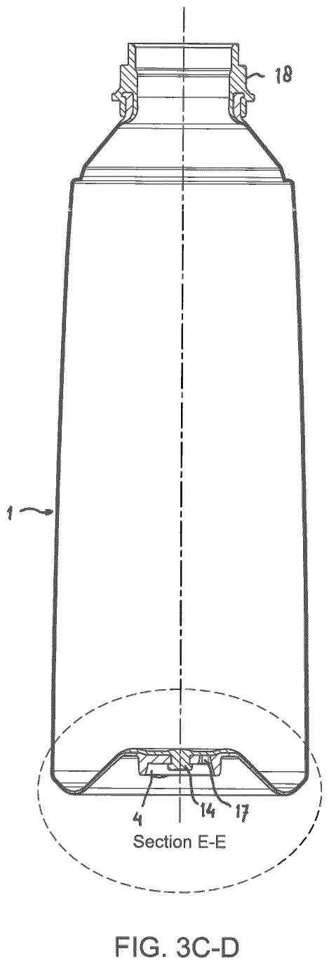

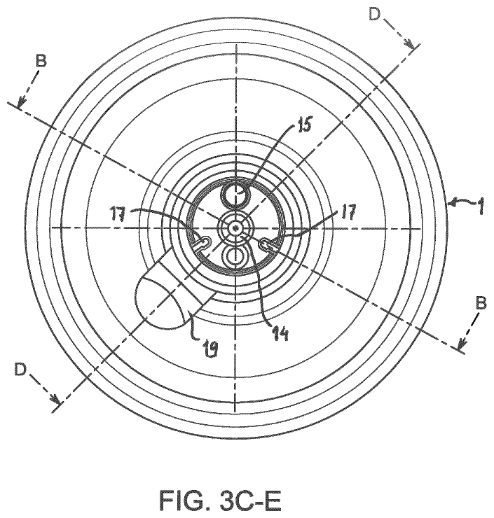

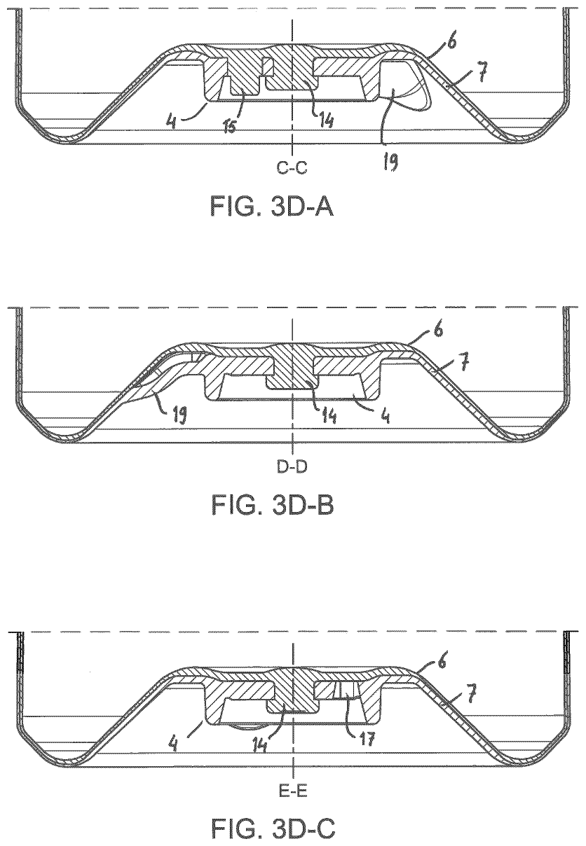

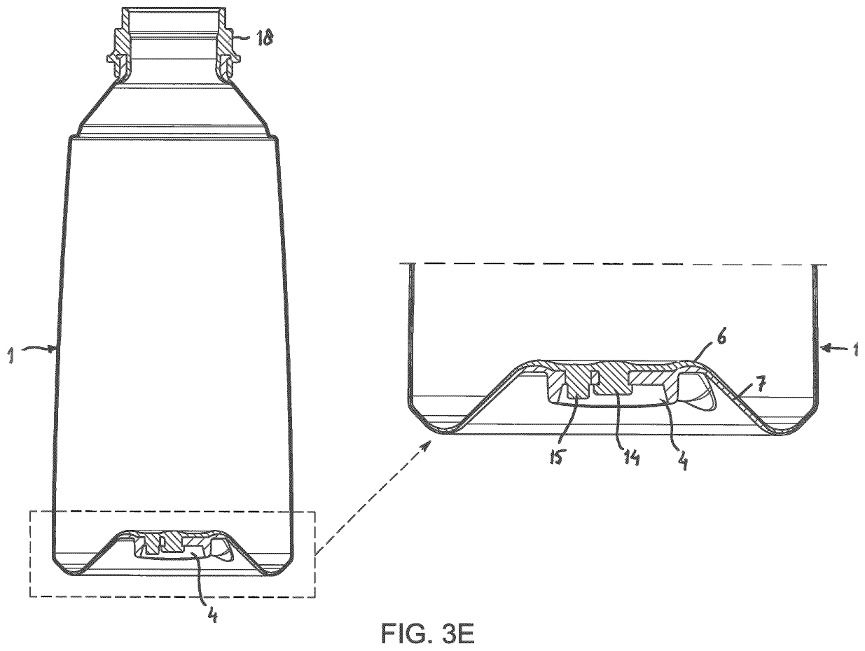

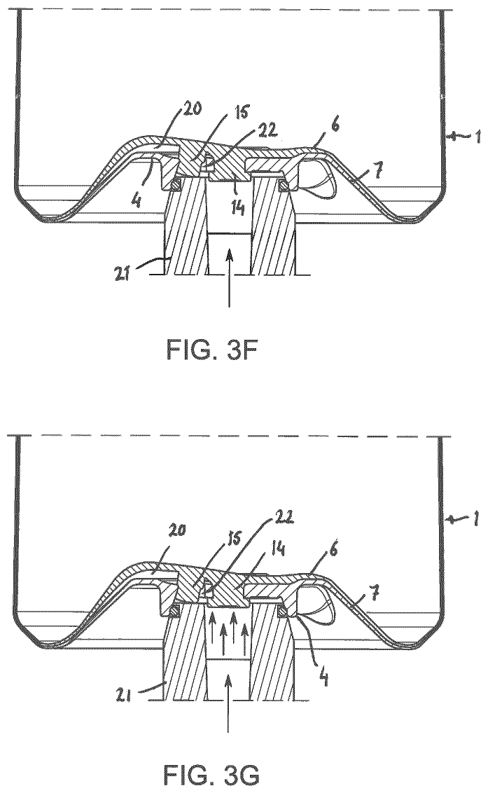

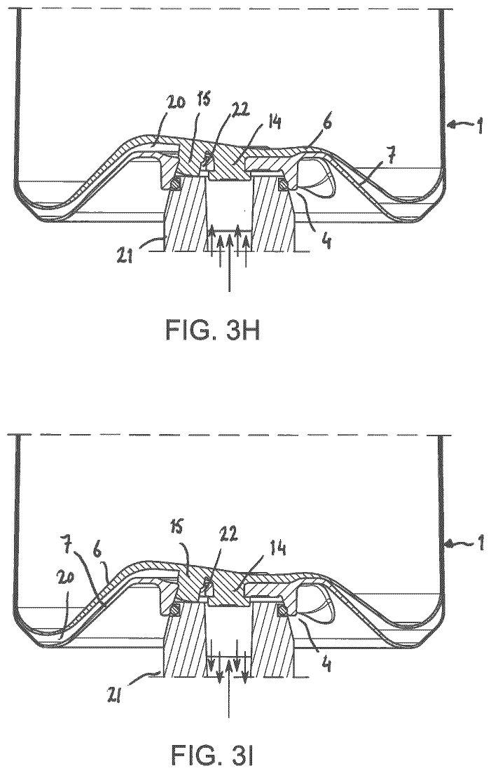

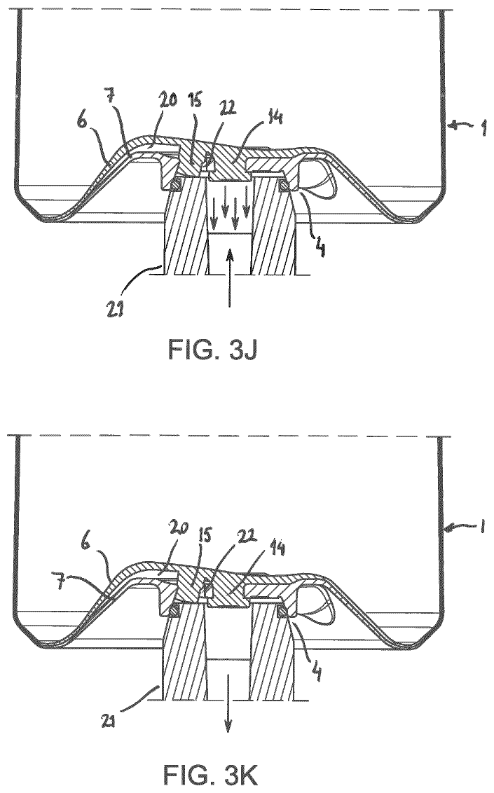

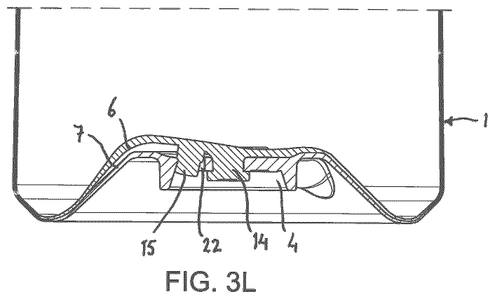

FIG. 3 provides the solution to this problem. FIG. 3 depicts perspective and longitudinal cross-section views of an exemplary bi-layer pre-form 2 (center image), provided with an air pressure release mechanism according to an exemplary embodiment of the present invention. This mechanism is part of the outer layer 9 of the preform 2, and is attached to it. As seen in FIG. 3, the outer preform 9 has a “U” shaped slit 10 in its bottom 11, as well as a central hole 12. When the inner layer 8 is molded, this inner layer 8 protrudes through the hole 12, as seen in the center image of FIG. 3, and also fills in the indent under the hole, as shown. Prior to removing the bottle 1 from its appliance 5 (as shown in FIG. 2), a user simply presses on the “pusher” 13 or air release mechanism which is built into the outer preform 9 (shown in gray in FIG. 3, right image). Given that the portion of the outer container with in the “U” shaped slit 10 is attached to the inner container at the central protrusion 14, by pushing on the “pusher” 13 at the vertex of the “U”, this releases the air pressure between the inner and outer pre-forms 8, 9, preventing any air trap. The air simply flows out of the air inlet 10, as shown in the far right image of FIG. 3, as it is at higher than atmospheric pressure between the containers of the bottle 1.

The air pressure release mechanism has other functionality. It can be pressed on after blowing the preform 2 into bottle 1 (as shown in FIG. 1) so as to release the inner container 6 from the outer container 7 (as shown in FIG. 2) after blowing. When molding, around the gating of each cavity the temperature will become hotter due to the fact that when the material enters into the cavity the temperature will rise close to the melting temperature of the other material and then the flexible portion of the inner layer 6 will stick to the outer layer 7. By pressing the button 13 (shown in FIG. 3) once the bottle 1 is blown, the inner bag 6 will thus release from the outer bag 7, allowing air or other displacing medium to fill the gap between the containers 6, 7, and thus facilitating the bag within a bag or “Flair” technology to operate. FIG. 3A illustrate details of a pre-form 2 such as is shown in FIG. 3, also without an air valve. With reference to FIG. 3A-A, there is a perspective bottom view at (a), and then a bottom view at (b) showing two lines through which cross sections are provided in the right side of the figure. As can be seen in the cross section running through line A-A, at (c), a variant of the pusher 13 of FIG. 3, namely a push pin protrusion 15, is seen which only appears on one side of the central axis. Such a push pin 15 concentrates the force at one point, thus making it easier to introduce the separation of layers 6, 7. It is also smaller, and thus easier to mold, inasmuch as it is part of the inner container 6. The other circular structure 16 (shown between the two ventilation holes 17) is not functional, rather a gating profile used in the molding process. There are additionally two ventilation holes 17 seen in (b), one of which is seen in the cross section through line B-B, to the right of the central connector 14, in FIG. 3A(d).

FIGS. 3B-A and 3B-B illustrate how the pre-form 2 of FIG. 3 can be blown to generate a full size bottle 1, where the neck 18 and the center of the bottom 4, 11 remain at their preform size, and the remainder of the preform 2 is blown to full size. FIGS. 3C-A, 3C-B and 3C-C show the same preform 2 of FIG. 3A now blown into a bottle 1. This bottle 1 is without an air valve, the air valve being in the appliance, as described below. FIGS. 3C-A and 3C-E provide a number of lines through which cross sections are provided in FIGS. 3C-B, 3C-C and 3C-D, and respectively magnified in FIG. 3C-E.

FIGS. 3D-A through 3D-C present detailed magnifications of the bottoms 4 of cross sections through lines C-C, D-D and E-E of FIG. 3C-E. With reference thereto, in FIG. 3D-B (as well as in 3C-E and 3C-C) there is shown a dimple 19 in the blowing mold. The outside layer 7 follows this shape and the inside layer 6 becomes loose after shrinkage. By creating an air gap 20 (shown in FIG. 3H) once the inner layer 6 shrinks this feature improves the separation of the layers 6, 7 and avoids “blocking” (sealing) of inside layer 6 against the outside layer 7 when the air has to quickly release. FIG. 3D-C shows one of the two air inlets, or ventilation holes 17, for introducing air between the inner layer 6 and the outer layer 7, as described above.

FIGS. 3E-3L, next described, illustrate the process of separation of the inner layer 6 from the outer layer 7 once the bottle 1 is full blown from the pre-form stage. With reference thereto, FIG. 3E shows the full blown bottle 1 and a detailed magnification of the bottom 4 of the bottle showing the push pin shaped layer separation device 15 as shown in FIG. 3A-C, section A-A. FIG. 3F shows the push pin 15 of the inside layer 6 being pushed upwards into the bottle 1 as an air supply device 21 (part of the “appliance”) is attached to the bottom 4 of the bottle 1.

FIG. 3G shows how the layers 6, 7 can be separated once the air supply device 21 applies a positive pressure into the gap 20 between the two layers 6, 7. This pressure flows somewhat through the space created by pushing up the push pin 15 and of course through the ventilation holes 17. FIG. 3H shows the continuation of this process and, as can be seen, the inner layer 6 has risen above the outer layer 7. Thus, a gap 20 has been created between them. In general, the layer separation can occur right after blowing, once the bottle 1 has cooled to 50-60 degrees Celsius. The process can also be done when the bottle 1 is fully cooled, if waiting is not an issue.

FIG. 3I shows the situation where the air supply device 21 now switches to an under pressure (partial vacuum) and sucks back the air that it had used to separate the layers 6 and 7. This is necessary to allow the inner container 6 to assume its full blown shape, and thus be fully filled with a full measure of the liquid it is designed to carry.

Additionally, from a marketing perspective, if an inner bottle 6 does not have its full shape, it may appear to the uninitiated as used and refilled, which is not desirable. FIG. 3J shows the continuation of the process as shown in FIG. 3I where the inside layer 6 has now assumed the shape of the interior of the outer layer 7 without an air gap, yet the layers 6 and 7 remain separable, to thus operate according to the Flair functionality.

FIG. 3K shows the culmination of this process where all the air that had been introduced to separate the layers 6, 7 is now removed.

FIG. 3L shows the end result of this process where now the push pin 15 hooks again into the hole 22 within the outside layer 7 and closes the gap. However, given the layer separation process as shown in FIGS. 3F-3K, there is a guaranteed separation of the layers 6, 7 during use (Flair bottles require the gap to be filled with the displacing medium), and thus avoiding blocking or sealing of the inside layer 6 against the outside layer 7 when the air has to quickly release.

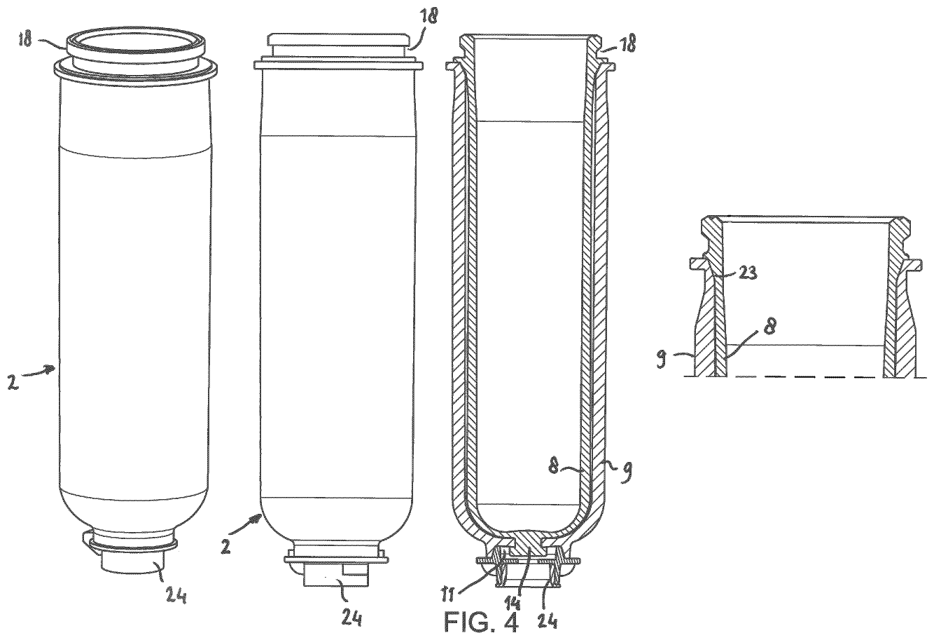

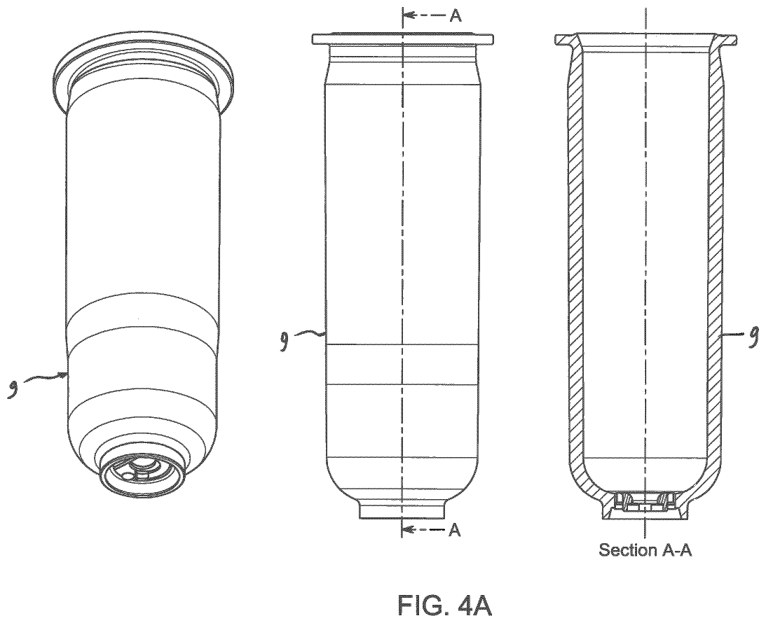

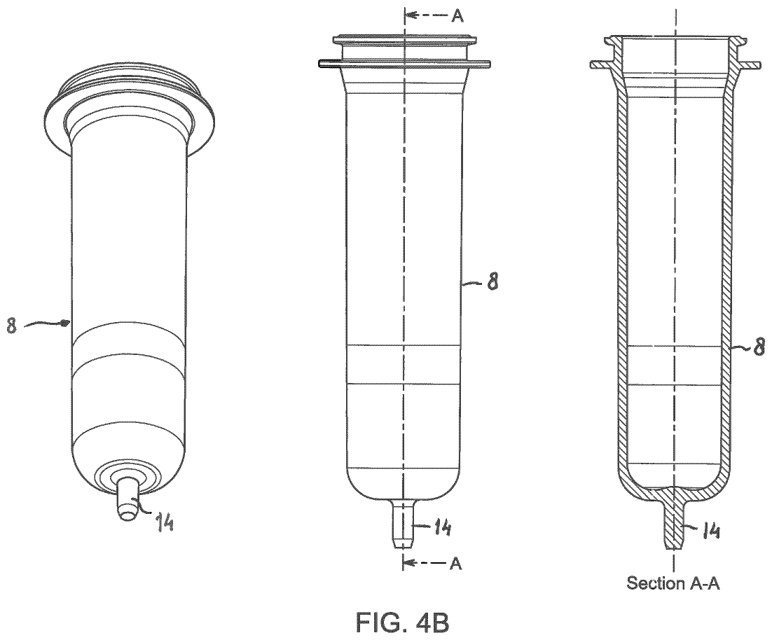

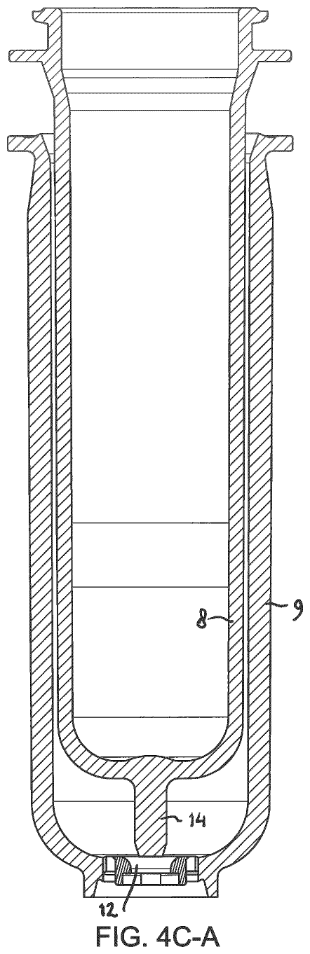

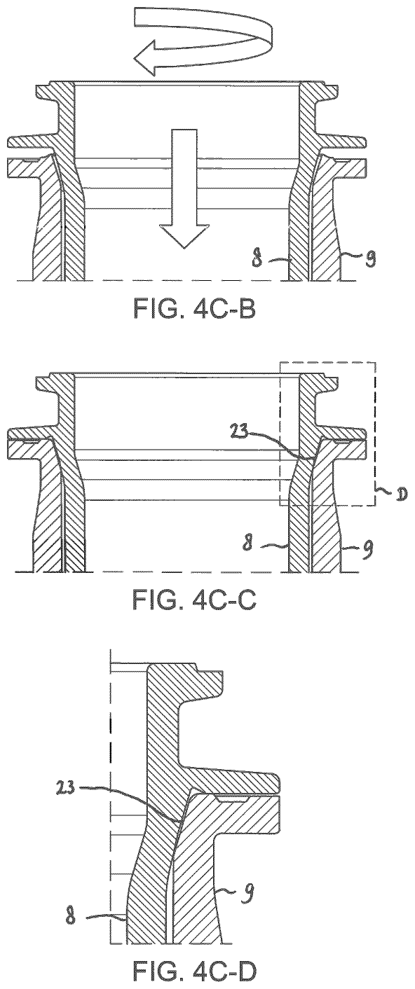

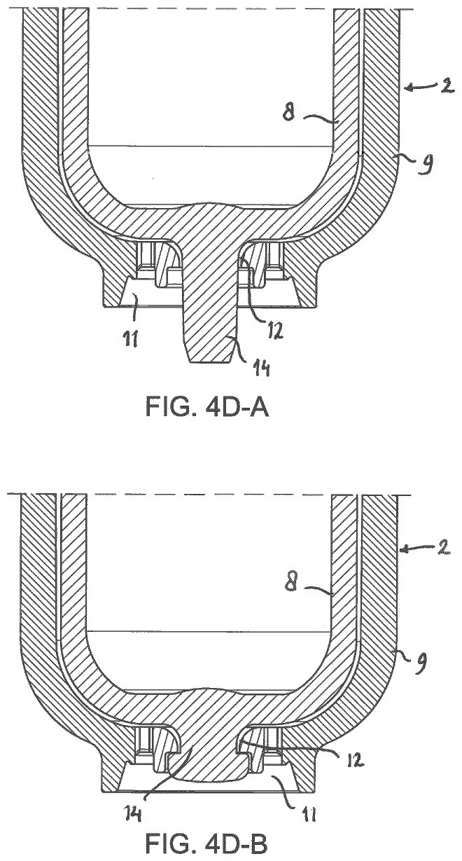

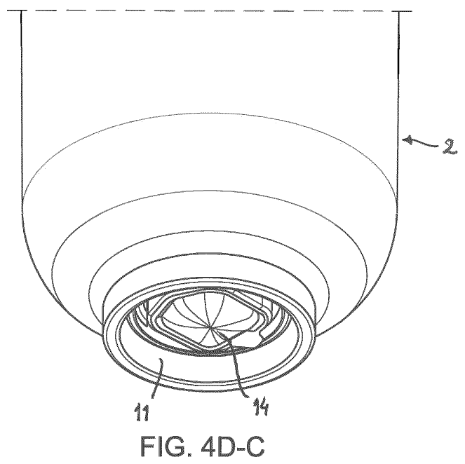

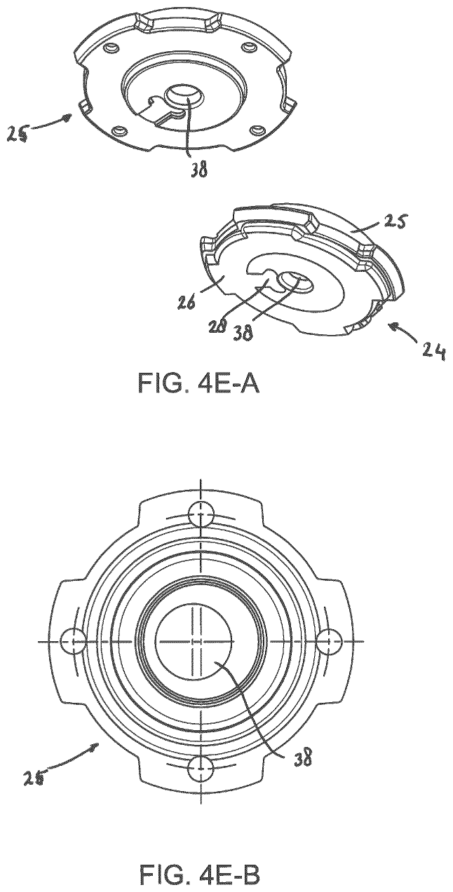

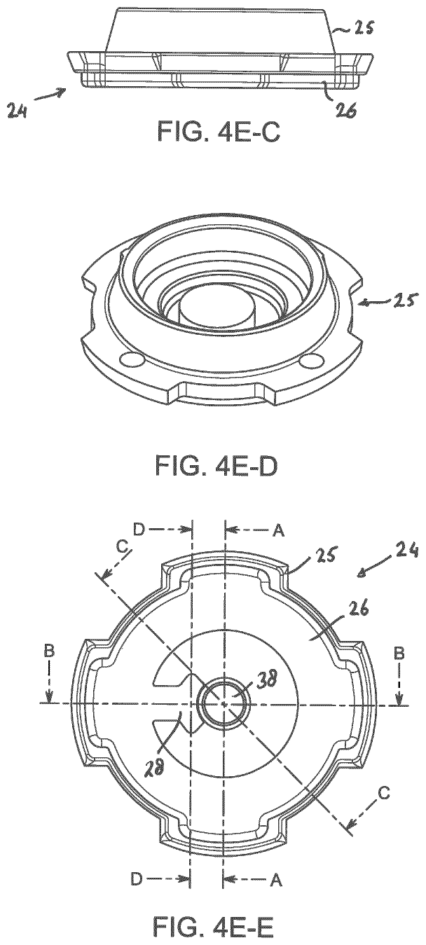

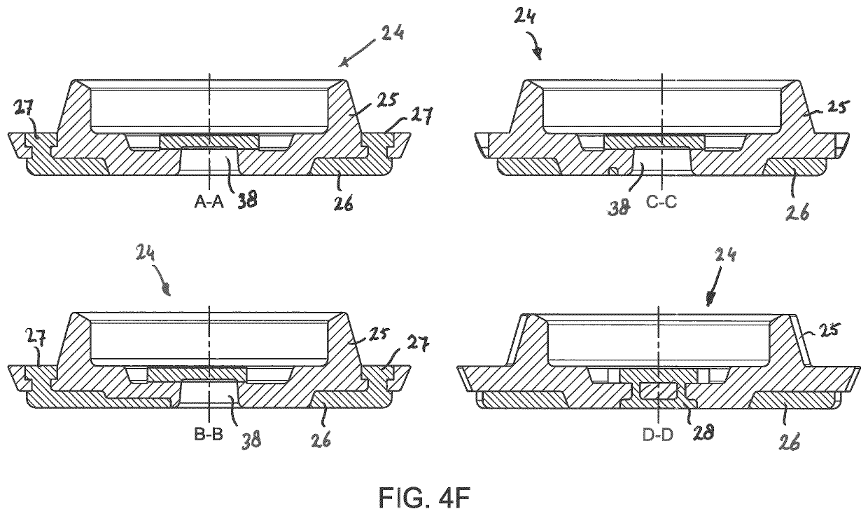

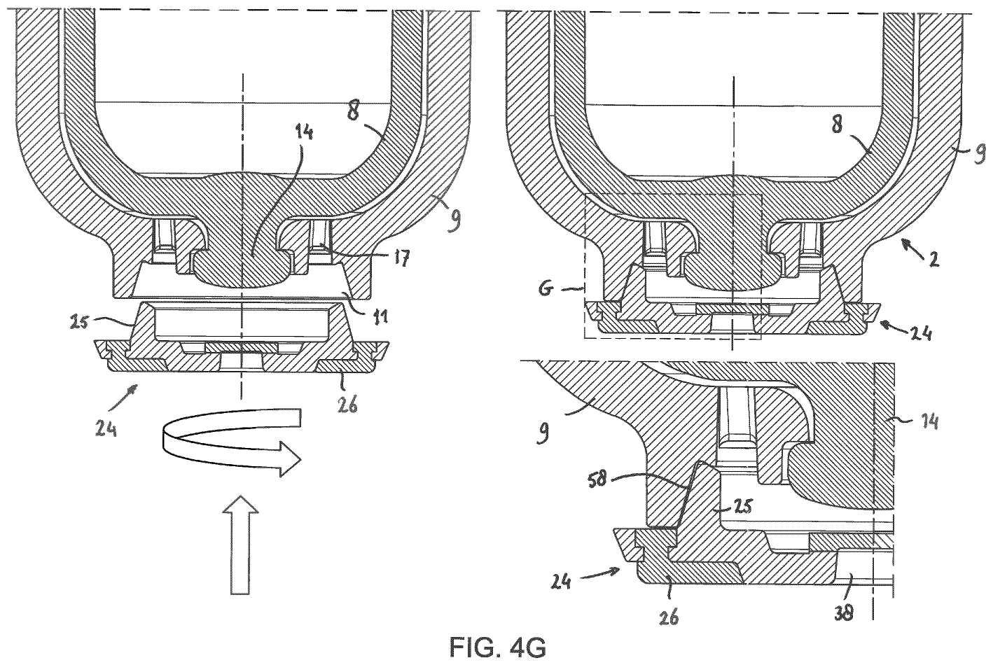

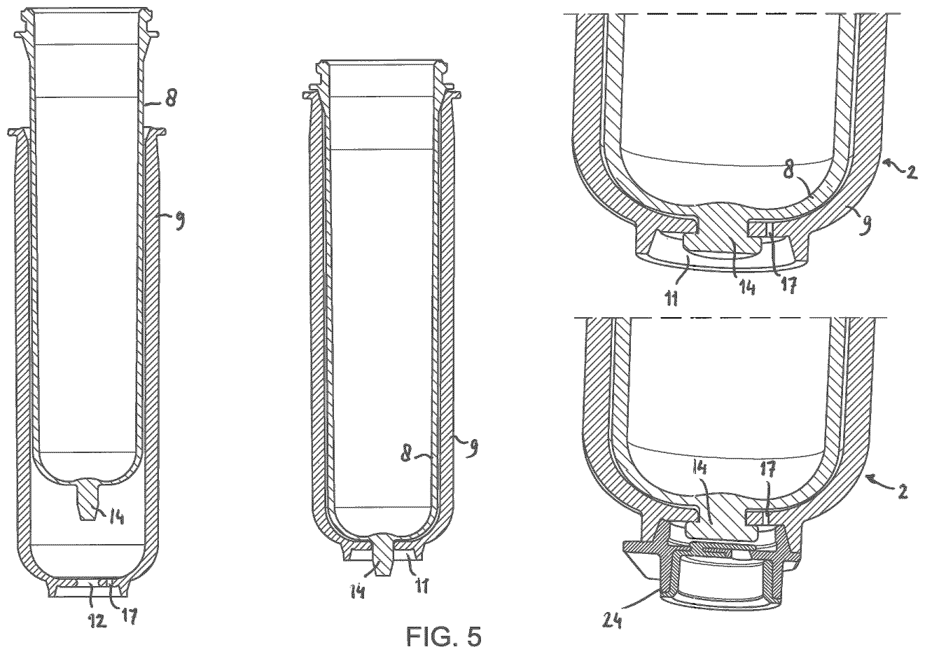

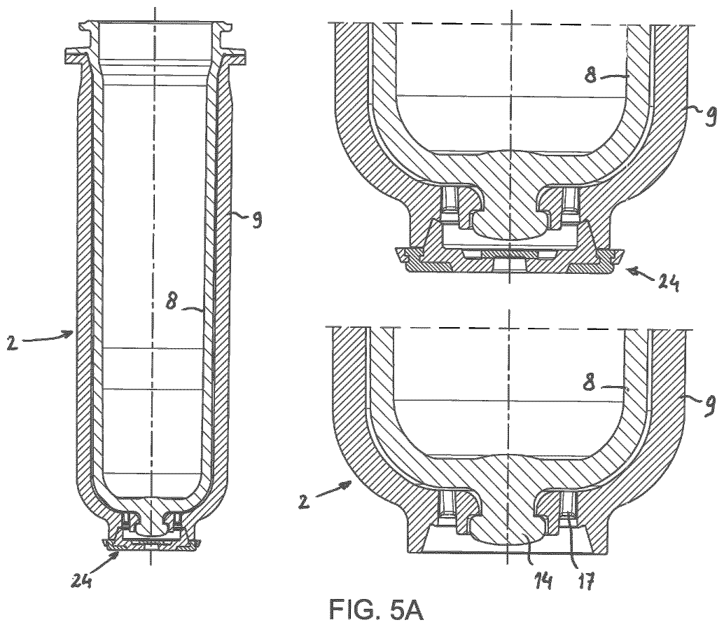

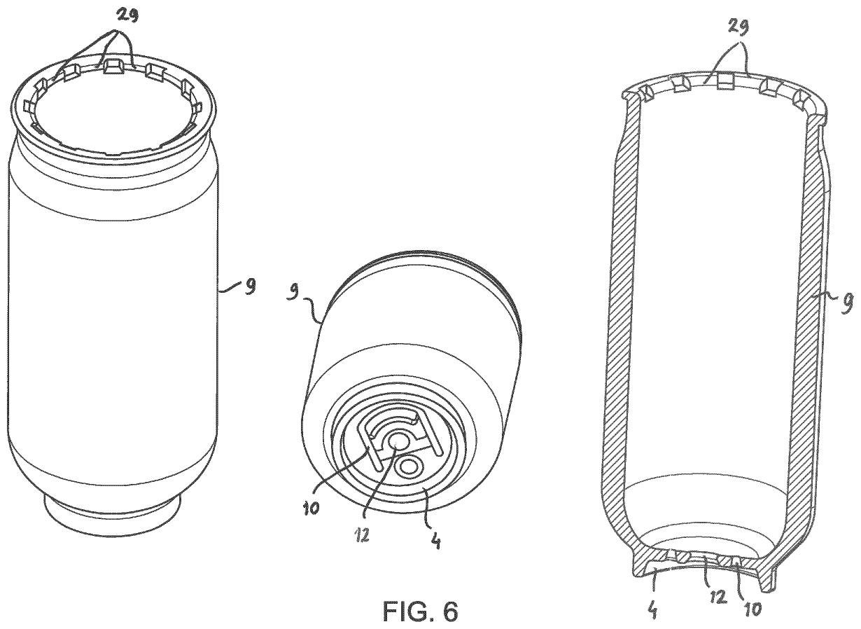

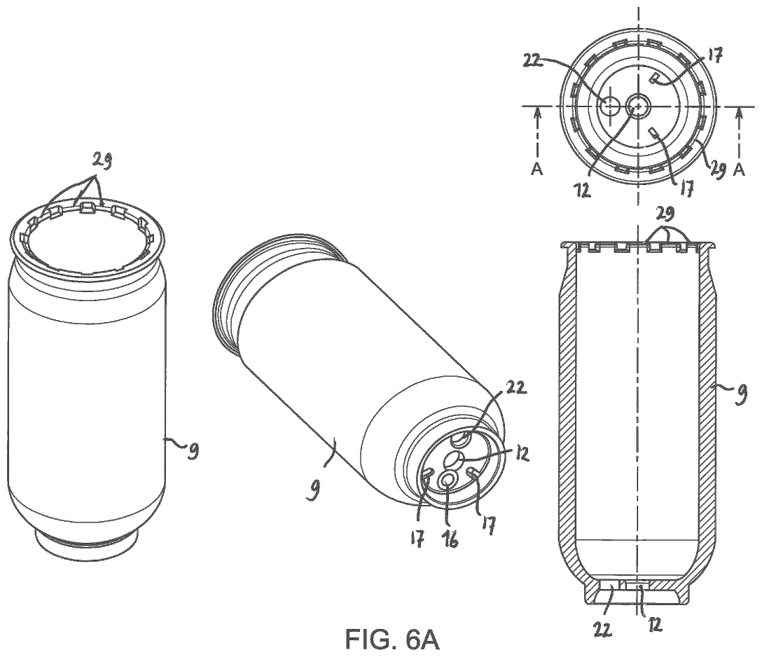

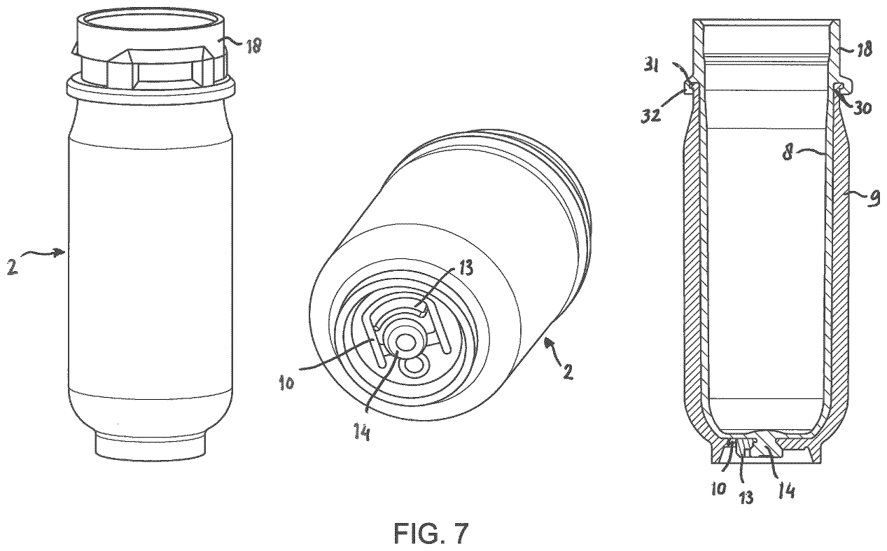

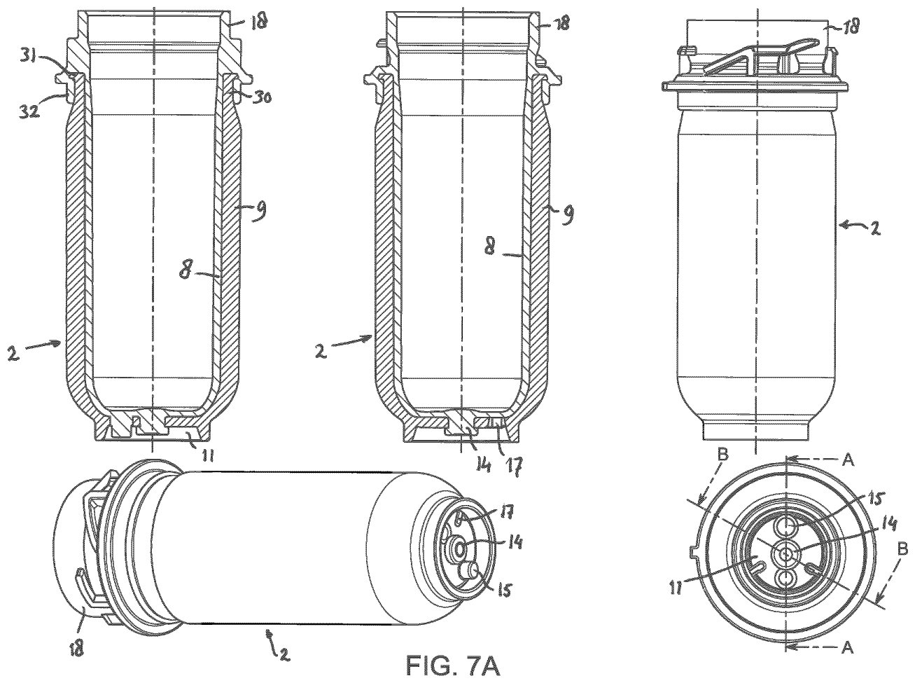

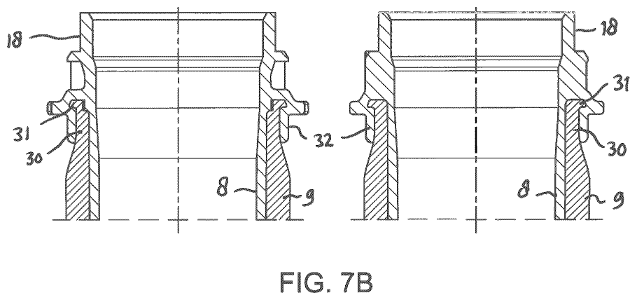

FIG. 4 depicts an exemplary preform where both the inner and outer pre-forms 8, 9 are made of PET, and where the inner and outer pre-forms 8, 9 are separately molded and then assembled. The top connection 23 is an airtight seal made by spin welding, for example, in a clean room type setup where dust and the like are controlled. These example pre-forms have a crimped neck, and can be used, for example, in home draft beer systems. Additionally, as shown in FIG. 4, besides the inner and outer pre-forms 8, 9 being joined at the top by spin welding, they are also joined at the bottom 11 by a protrusion 14 from the inner container 8 which is then flattened. The lower connection can be done using 2C molding, or, for example, by ultrasonic welding. In addition, a valve 24 can be affixed underneath the two pre-forms 8, 9, as shown at the bottom of the preform in FIG. 4 and in more detail in the far right image of FIG. 5. The valve 24 can be affixed by, for example, rotation welding, or other affixation techniques.

FIGS. 4A-4DC provides additional details of a standard Flair type PET/PET pre-form shown in FIG. 4 (the term “standard Flair” is used in contrast to “Piston Flair” where the upper portion of the inner container 6 is affixed to the upper portion of the outer container 7, such that when dispensing its contents the inner container 6 folds along itself much like a piston). With reference thereto, FIG. 4A(left image) shows a perspective view of the outer container 9 of the pre-form 2 and FIG. 4A(center image shows a side view with a line A-A through which a cross section is taken and presented in FIG. 4A(right image).

Similarly, FIG. 4B shows the inner layer 8. Visible at the bottom is the plug 14 by means of which the inner container 8 will be affixed to the outer container 9 as shown in FIG. 4, and a side view and a cross section through the line B-B. Similarly, FIG. 4C shows how the inner container 8 is assembled into the outside layer 9. This process can, for example, be accomplished by initially inserting the inner container 8 into the outer container 9 and then pushing down and spin welding such that there is a melted area 23 at the top of the pre-forms 8, 9 where the inner and outer layers are connected. This is shown in FIGS. 4C-A through 4C-D, as shown. The connection of the inner layer 8 to the outer layer 9 has to be an air-tight connection. Alternatively, the two layers 8, 9 can be connected by ultrasonic welding, heat stamp etc., the main requirement being an air-tight connection.

FIGS. 4D-A through 4D-C show how the central pin 14 of the inner layer 8 protruding through the bottom 11 of the outer layer 9 can be deformed so as to connect the inner and outer layers 8, 9. This can be done by deformation of the central pin 14, or for example, by deformation by spin welding, ultrasonic welding, heat stamp, etc. This connection at the bottom 11 need not be air-tight. In fact, when an air supply device is connected to the bottle, some of the air will travel through this pin connection in various exemplary embodiments.

### One Way Valve at Bottom

FIGS. 4E, 4F and 4G illustrate details of a one way valve 24 to be used in connection with exemplary preforms as described below. With reference to FIGS. 4E-A through 4E-E, a first step can be injection molding of PET 25 for reason of the spinweld connection with the outer layer 9 of the preform, and a second step can be, for example, soft TPE 26, not chemically connected to the PET (but mechanically affixed to the bottom of the TPE portion at 27 and 28, as shown in FIG. 4F). A soft material can be used for two reasons: (1) good sealing of the valve, and (2) to create a good sealing to the air supply device (which connects to the underside of the TPE portion, for example). As shown in FIG. 4G, the one way valve 24 can be connected to the exemplary preform 2 at 58 using spin welding, ultrasonic welding, gluing, etc.

FIG. 5 depicts an exemplary bi-layer pre-form 2 without an air valve, shown by itself, and as connected to an air valve 24. The air valve 24 can be supplied by, for example, an appliance that has a built in air-valve (shown at bottom right image), or it can be attached to the bottom 11 of the pre-form 2 as described above, via rotation (spin) welding, for example. Alternatively, it can be attached using other connection methods as may be available, such as ultrasonic welding, gluing, etc. If the air-valve housing and the air-valve are part of the appliance 5 (see FIG. 1) into which the bottle 2 (here shown as a pre-form) can be inserted, such an appliance 5 can provide the clamping system which seals the bottle 1, as shown in FIG. 1. FIG. 5A shows details of the preform of FIG. 5 with and without a power connector or power pack with a pump and air valve 24.

### Standard Flair PET/PP Preforms

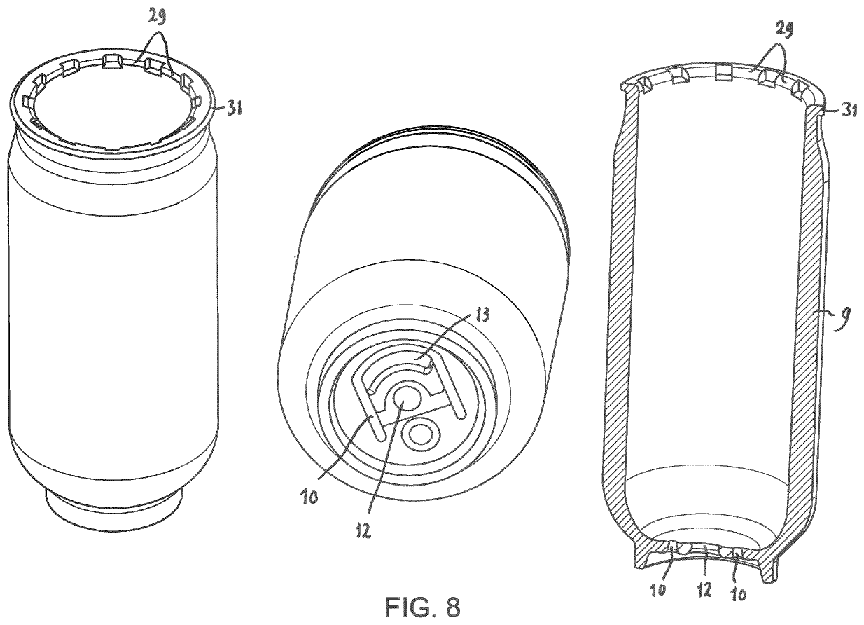

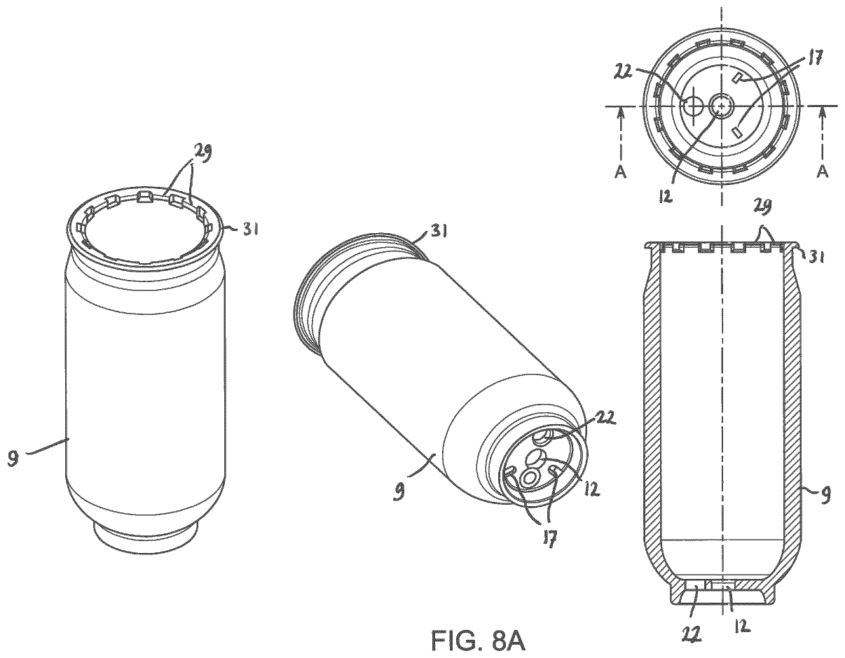

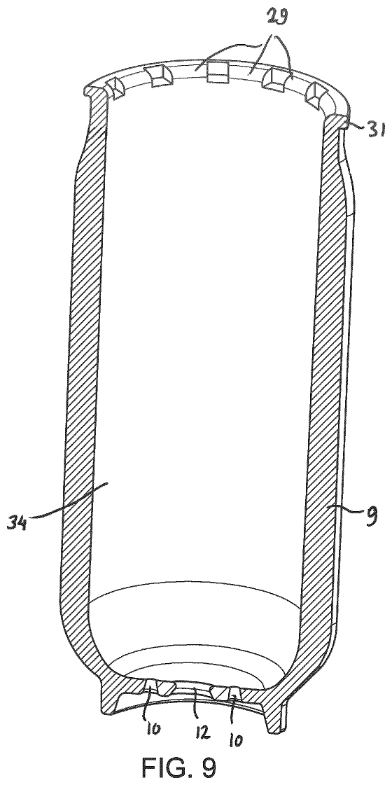

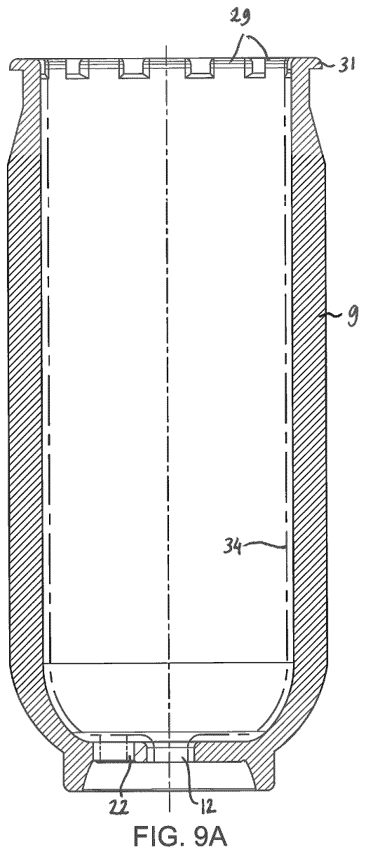

FIGS. 6-7 depict two stages in the manufacture of an exemplary PET/PP pre-form 2 with bayonet type connection at its top, and for use with standard Flair devices. Here the outer PET pre-form 9 is first molded, and then, in a second step, the inner pre-form 8, made from a polyolefin, such as, for example, polypropylene, can be molded. This can be done in a bi-injection molding process, where (FIG. 7) the inner preform 8 is injected into the hole 12 in the outer pre-form 9. By leaving a small protrusion 14 of the inner pre-form 8 on the outside of the outer pre-form 9, they become attached. FIG. 6A shows how hooks 29 are used, to avoid turning of the inside layer when the bottle is blown and the device is placed or removed by turning.

Thus, in FIG. 7, middle image, there is seen a circular disk like protrusion 14 of the inner pre-form 8 at the center of the bottom 11. This disk like protrusion 14 fastens the inner pre-form 8 to the outer pre-form 9 at the bottom see right image of FIG. 7). As noted above, this exemplary outer pre-form has a “pusher” 13 or pressure release mechanism built into its bottom portion. This mechanism works once the pre-form 2 is blown into a bottle.

In connection with FIG. 7 it is also noted that here the inside layer 8, for example of polypropylene, is used to form the neck 18 of the bottle. Thus, it can be overmolded over the neck 30 of the outer pre-form 9, and due to the greater shrinkage of the PP inner container 6 as it cools after being blown, the inner container 6 completely seals in a “shrink-wrap” effect, over and around the outer container 7. FIG. 7A shows details of the inside polypropylene layer 8. FIG. 7B highlights its novel geometry to obtain a tight sealed connection between the two layers 8, 9. To get an air tight connection between inner and outer layers 8, 9, the inner layer 8 has to be over molded OVER the outer preform 9. For reasons of shrinkage, the inner layer 8 after injection molding is not air tight with the outer layer 9. However, when the inner layer 8 is OVER the outer layer 9 as shown in FIG. 7B, it creates an air tight sealing between the two layers 8, 9 after blowing. As shown, for best results the inner layer 8 not only covers a protruding ring 31 of the outer layer 9, as shown in FIG. 7, but alternately, protrudes downward somewhat, making a ring 32 that covers the outer layer 9 for some distance below the upper terminus of the outer layer 9. Alternative possibilities for this connection can include ultra-sonic connection, glue connection, etc.

It is this same difference in shrinkage between the inner layer 6 and the outer layer 7 that allows another feature of a PET/PP—or similar mix of inner/outer container materials—for a Flair bottle. If, for example, a PET bottle is used with a PP or polyamide bag inside, then, after the pre-forms have been blown into an inner container 6 and an outer container 7, and allowed to cool, both containers 6, 7 will shrink. However, the inner bag will shrink more, as noted. Therefore, a space develops between the outer PET bottle and, for example, a PP bag or inner container. Often it is desired to “hotfill” a given liquid into its bottle without having to let the liquid cool. Hot filling of, for example, juices or sauces, condiments, etc., involves filling of a container with liquids having temperatures of from about 80° C. to about 120° C.

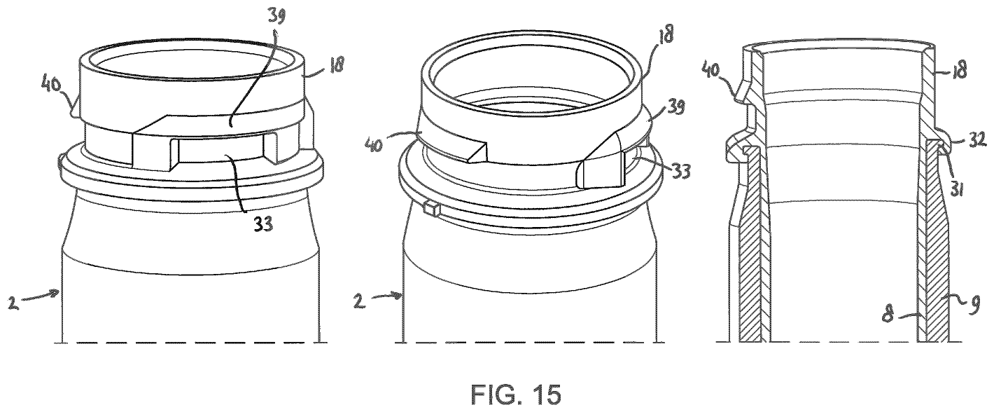

These high temperatures permit simultaneous filling and sanitizing of the interiors of the containers. Moreover, as soon as the liquid is produced in a hot state, it can be bottled and shipped, with no requirement of cooling areas or storing all of the bottles until the liquid cools and only then filling them, etc. Such hot filling of a product in a PET bottle is impossible, for the reason that PET will deform at temperatures above approximately 60° C. However, other materials used for the inner layer, such as, for example, polypropylene and other polyolefins, or, for example, various polyamides, do not have this problem. They have deforming temperatures generally above 90° C., for example. Thus, such a product can be, for example, hot filled in an inner polypropylene bag made from a pre-form such as is shown in FIGS. 6-7, or as in FIG. 17. The air between the PET outer bottle and the PP inner bag in such a Flair type container serves as a thermal insulator, and thus the, for example, PP inner bag can be filled with hot juices, sauces, condiments, etc. up to approximately 90° C., without any damage to the outer container made of, for example, PET. In exemplary embodiments of the present invention, the exact maximum hot fill temperature will depends on the shrinkage difference between the two layers 6, 7, and thus the thermal insulation provided by the air or other displacing medium between the two layers 6, 7. In exemplary embodiments of the present invention, the material from which the inner container is made, and the degree of shrinkage it will experience relative to the outer container 7, and the concomitant hot fill maximum temperature it can thus support, can all be designed for a given application, use or range of uses, all by proper design and manufacture of the pre-forms 2.

### Standard Flair 2C PET/PET Preforms—Outer Layer First

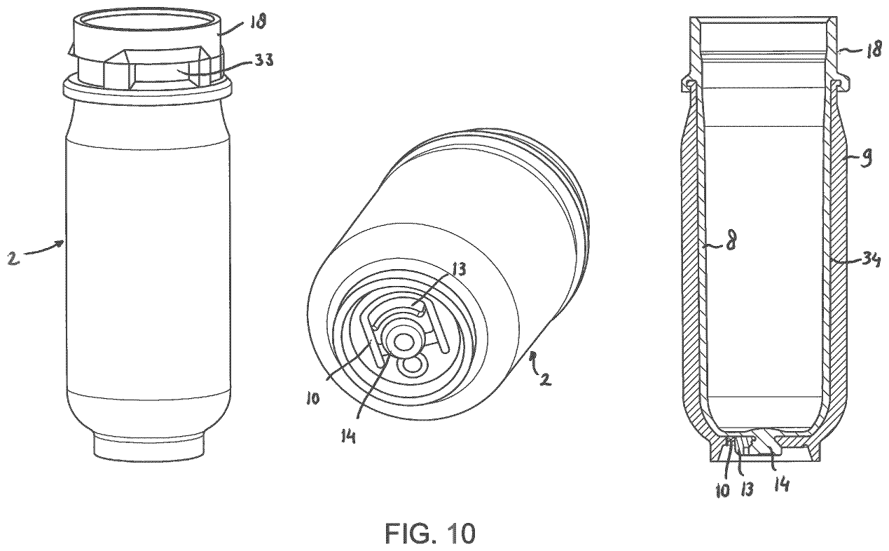

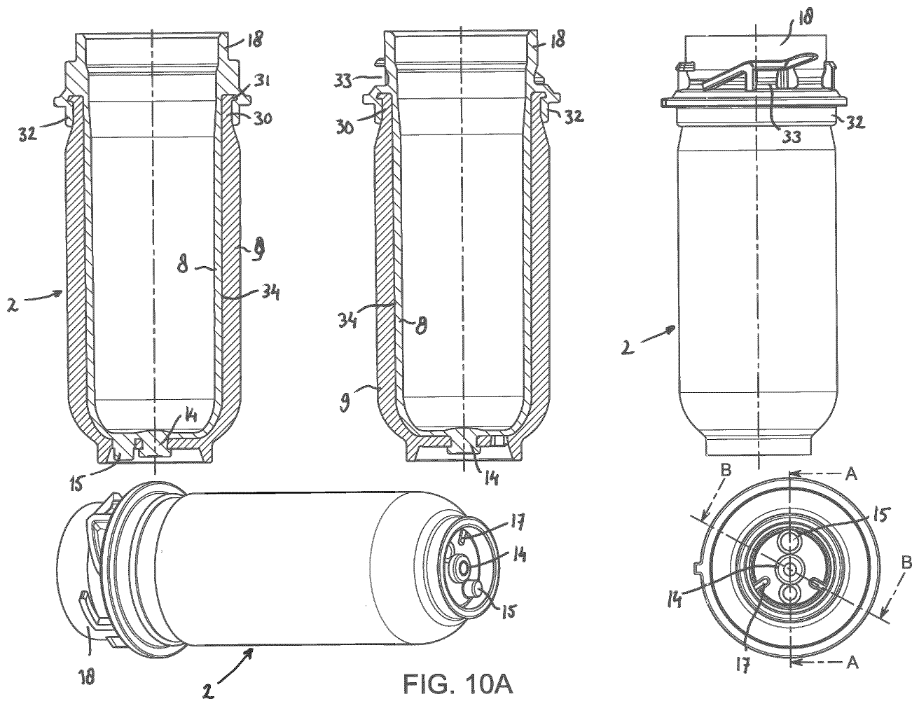

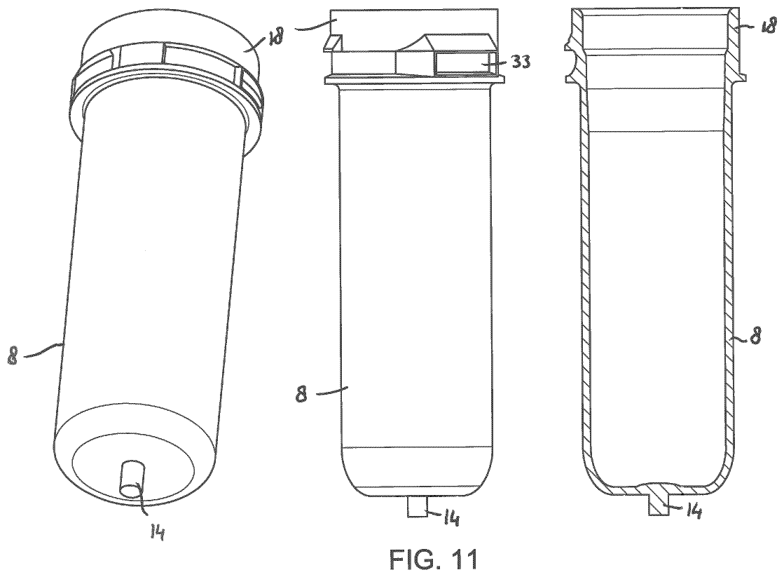

FIGS. 8-10 depict two stages in the manufacture of an exemplary pre-form 2 made from the same material type, such as, for example, a PET/PET pre-form, according to exemplary embodiments of the present invention. The example pre-form 2 shown here has a “bayonet” type neck 18 (horizontal recesses 33 provided in top portion of inner container to mate with “lugs” or horizontal protrusions of a dispensing head, or the reverse), but the process equally applies to any neck type. In FIG. 8 the outside layer 9 is molded first, for example, from PET. Then, in FIG. 9, before the second layer, i.e., inner layer 8, is molded, especially because the two materials are the same (and thus tend to fuse at the same temperature), a non-stick coating 34 can be provided on the inside surface of the outer preform 9. Such a non-stick coating 34 can be sprayed, for example, offset, or can be provided using other techniques as may be available or desirable. FIGS. 8A and 9A show details of these preforms, and depict the variant “push pin” 15 type layer separation device of FIGS. 3A-3L. It is noted that if one has the same materials for the inner and outer layers of a preform, or has two materials with the same molding temperature, then it can be useful to mold an inner preform 8 first. Advantage is that it is easier to precisely apply the non-stick coating 34 to the inner preform 8 than to the outer preform 9.

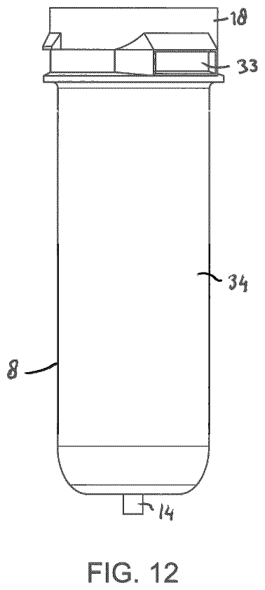

Finally, as shown in FIG. 10, the inside layer 8, also of PET, can then be molded. Because there is a non-stick coating 34 between the two layers 8, 9, they can later be separated once a displacing medium is introduced between them. FIG. 10A shows details of the inner layer 8 of such a PET/PET perform having the bottom structures of the type of FIGS. 3A-3L.

### Standard Flair 2C PET/PET Preforms—Inner Layer First

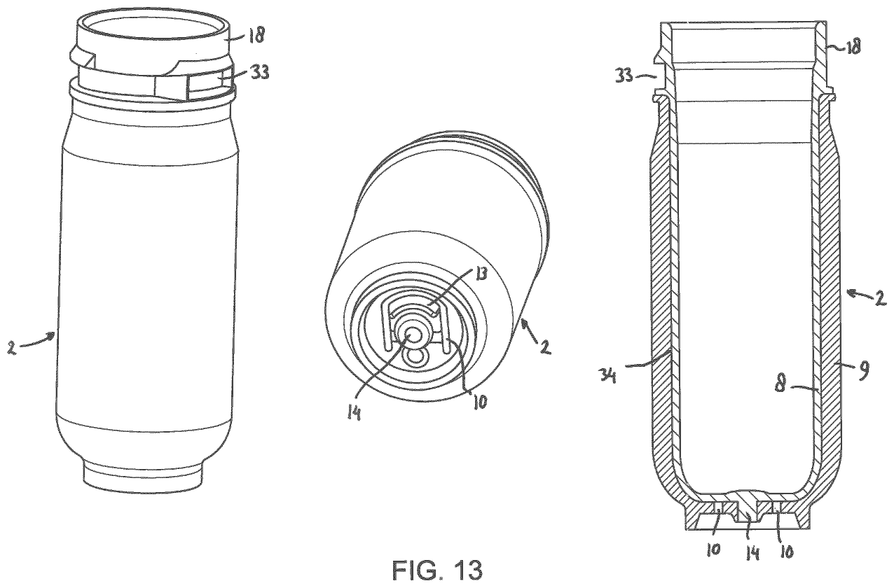

FIGS. 11-14 depict two stages in the manufacture of a PET/PET pre-form 2 according to alternate exemplary embodiments of the present invention. Here the inside layer 8 is molded first, as shown in FIG. 11. Then, in FIG. 12, before the second, i.e., outer layer 9, is molded, a non-stick coating 34 is sprayed or otherwise applied, affixed or provided on the outside surface of the inner perform 8. Finally, as shown in FIG. 13, the outside layer 9, also of PET, can be molded (see right image). However, here, because the inner layer 8 was molded first, and it was not provided with an elongated protruding disk as in the earlier case of the PET/PP pre-form of FIGS. 6-7, a variant means of attaching the two preforms 8, 9 together is needed. This is shown, for example, in FIG. 14.

FIG. 14 thus shows a two-step attachment process. First, in Step 1 (left image), a hole 35 can be provided in the inner layer of the inner perform 8 as it is molded. Then, in a Step 2 (right image), when the outer perform 9 is molded, it is provided with an upward protrusion 36 which protrudes upwards through the inner layer 8 and into the cavity of the inner layer, and thus closes the hole 35 in the inner pre-form and connects the two preforms 8, 9 together.

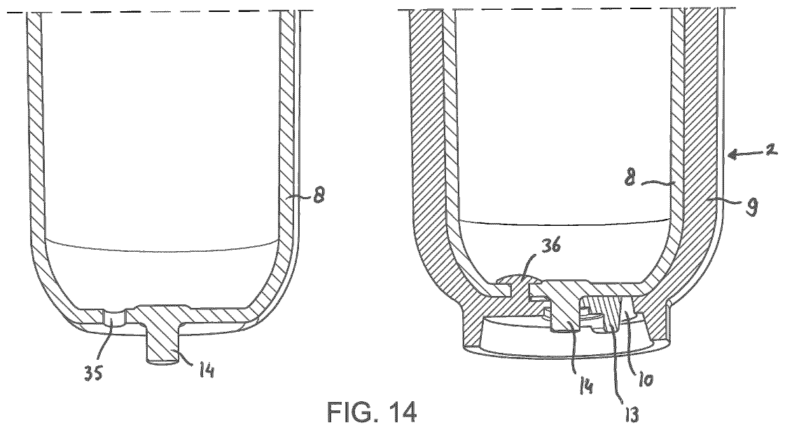

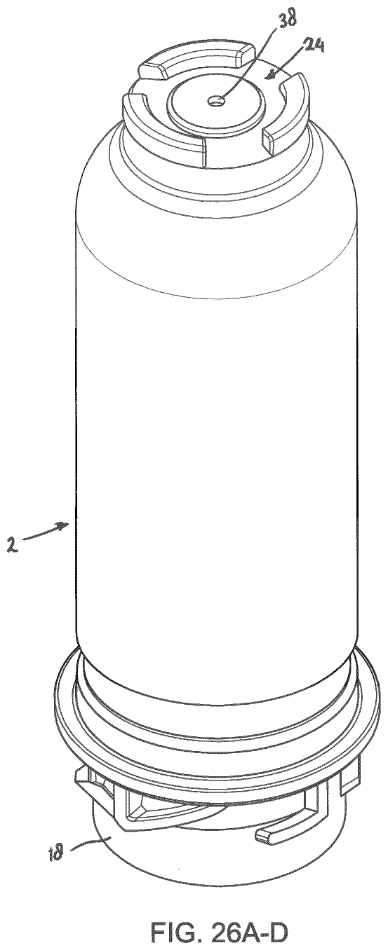

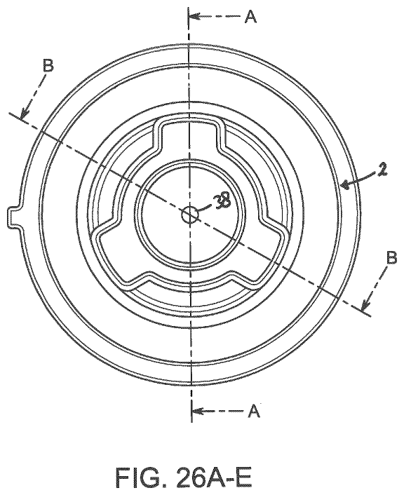

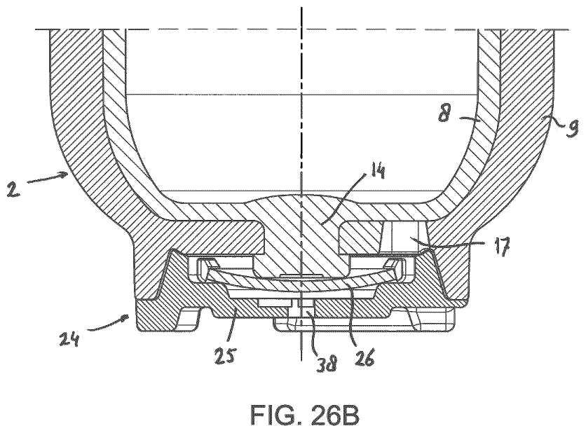

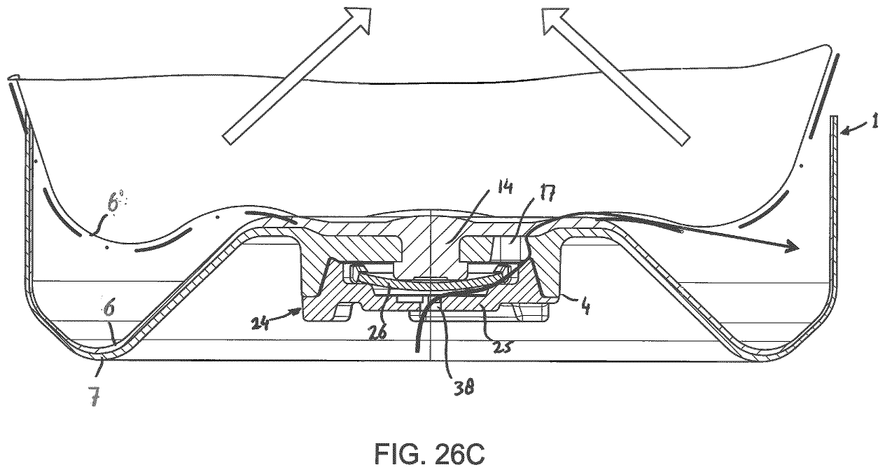

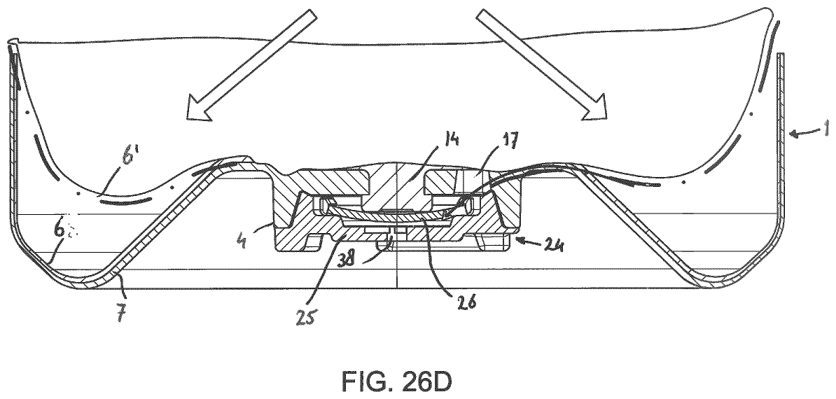

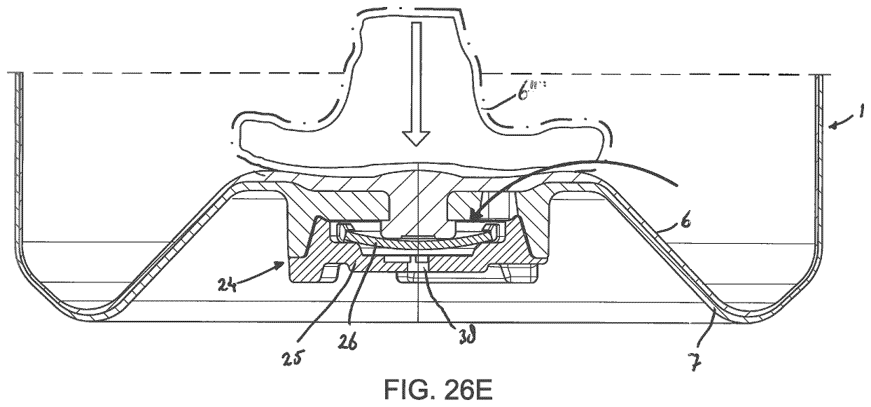

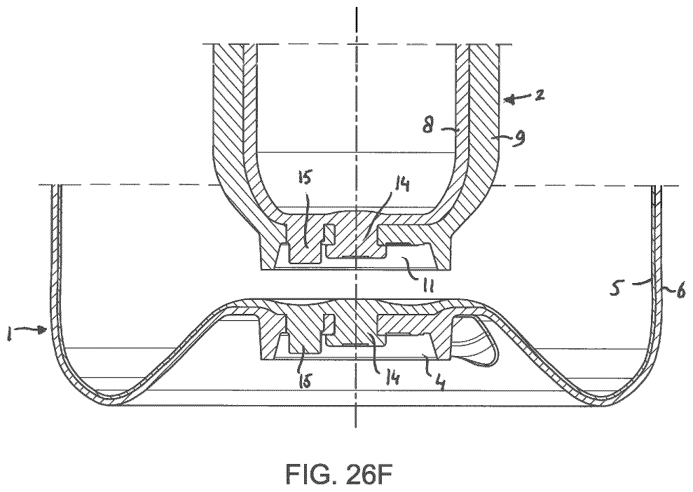

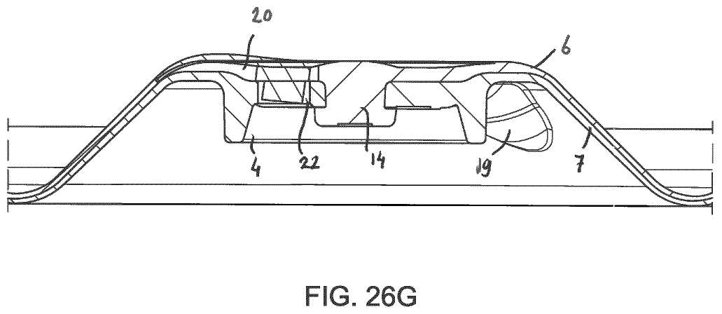

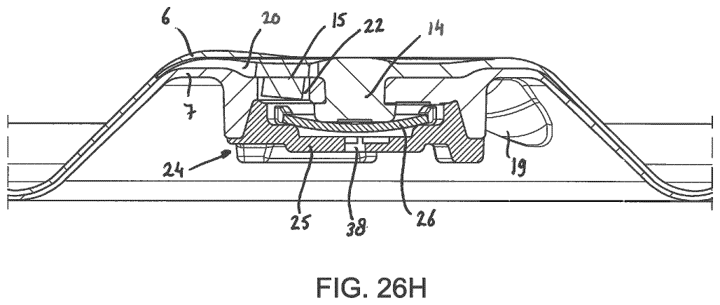

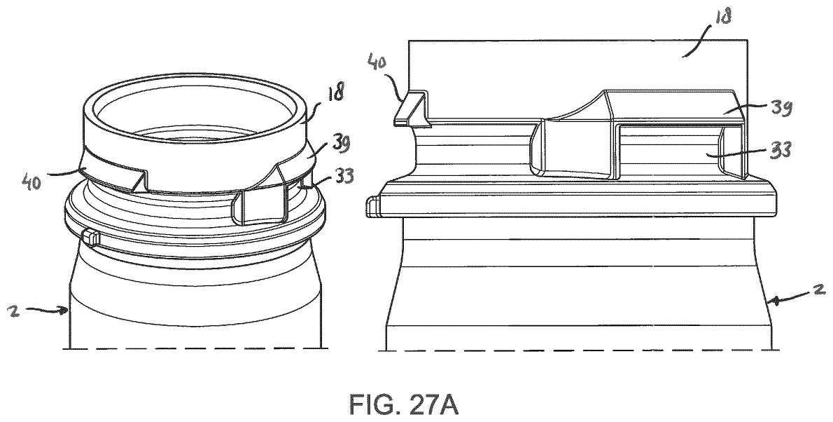

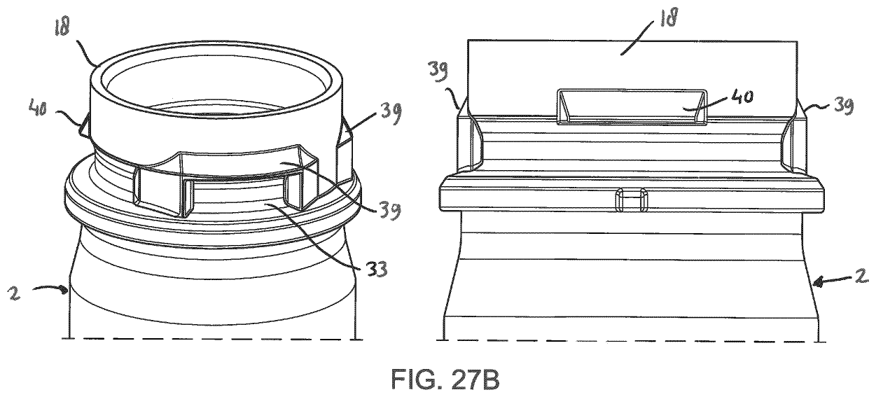

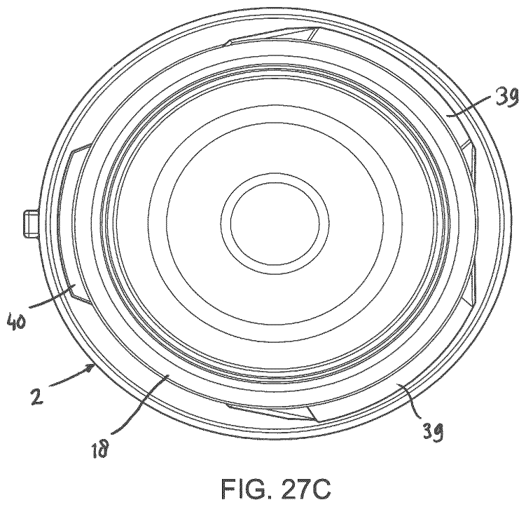

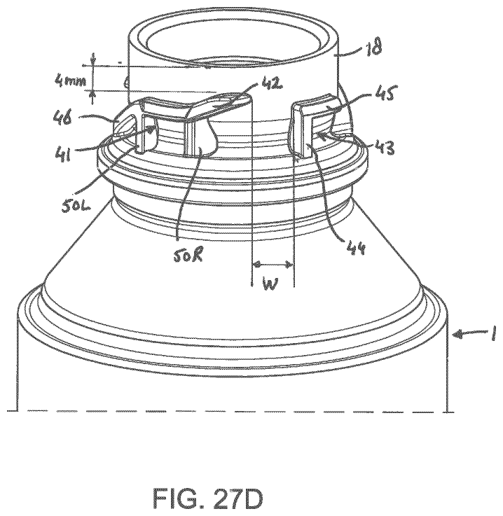

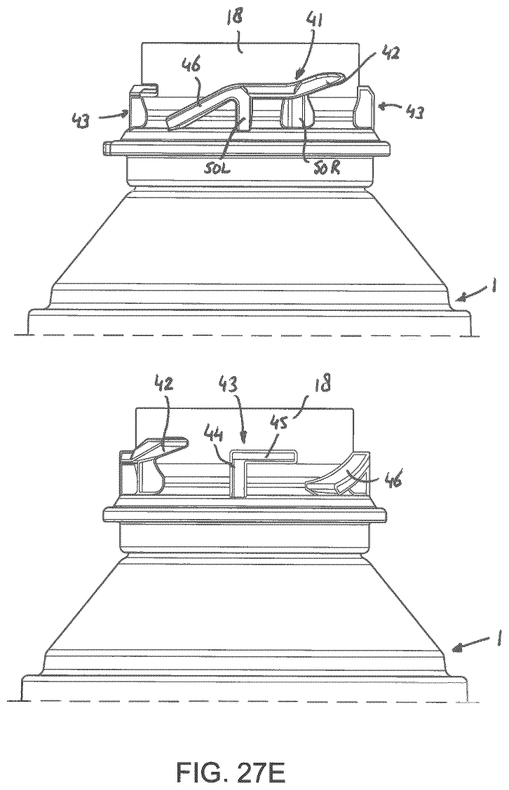

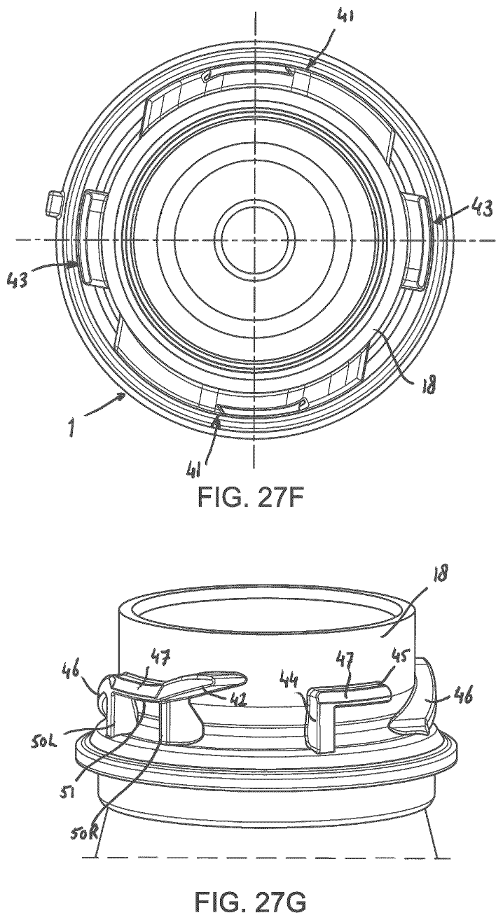

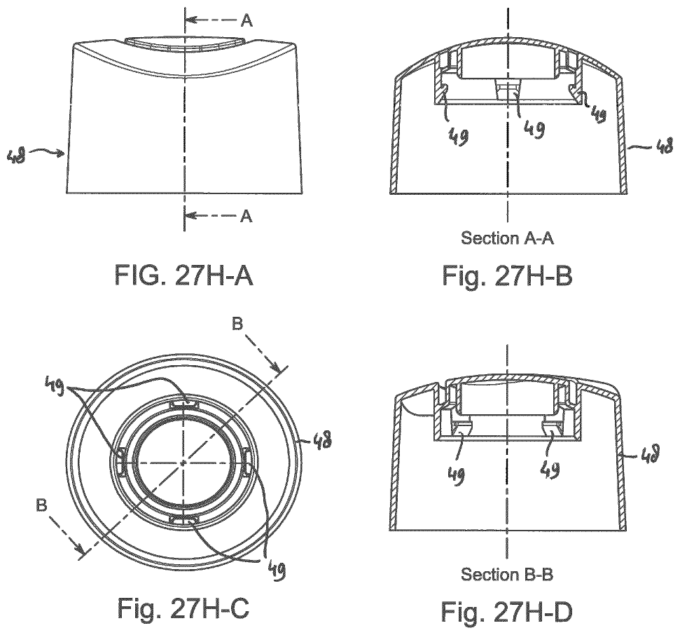

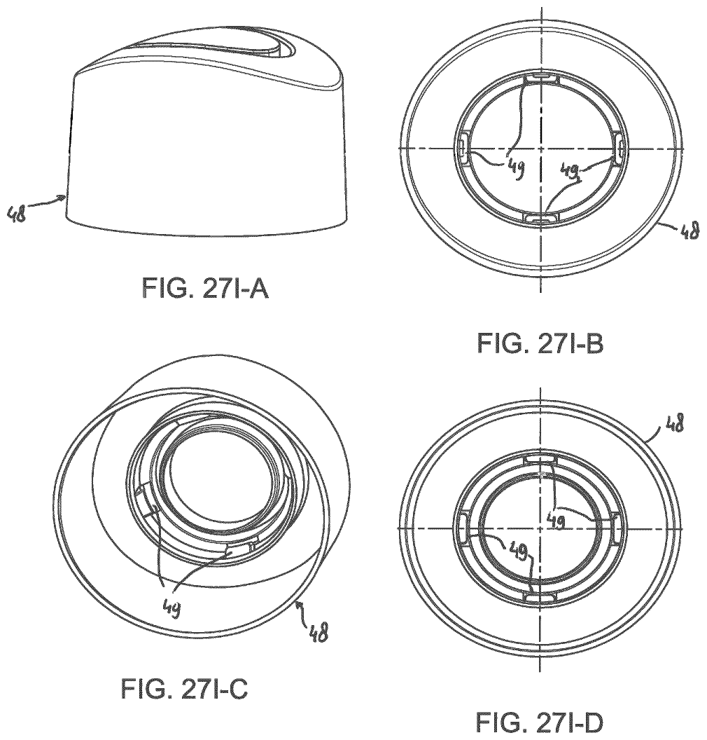

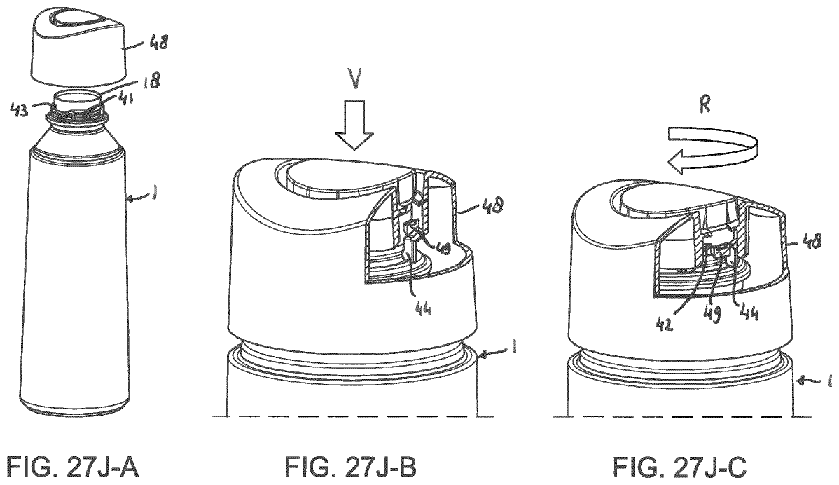

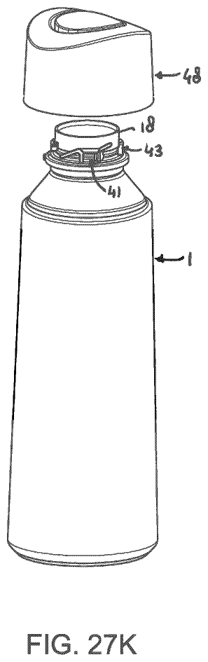

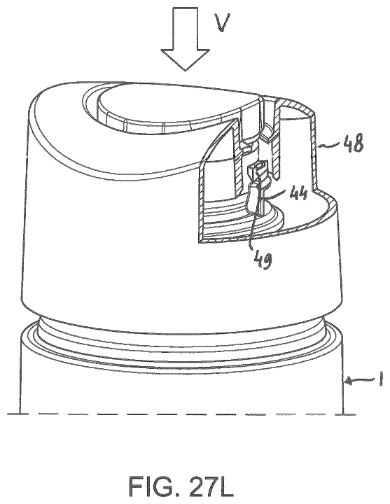

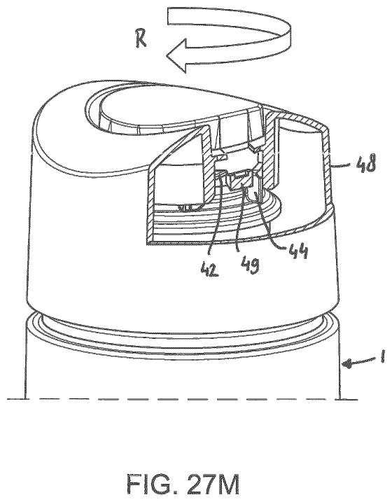

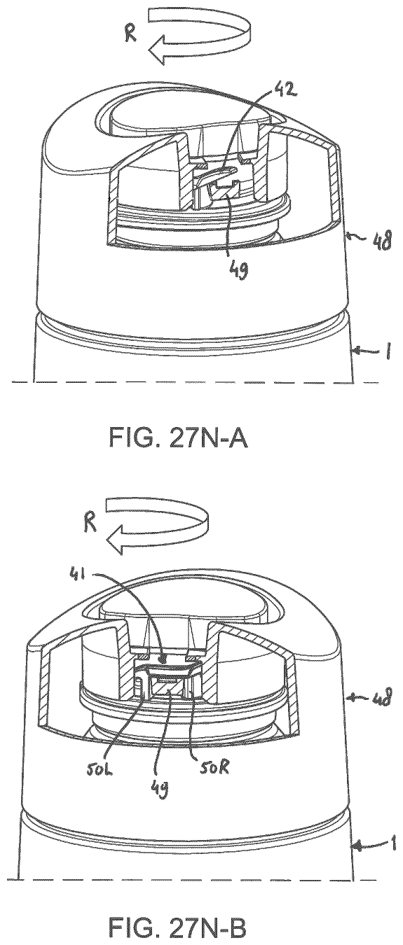

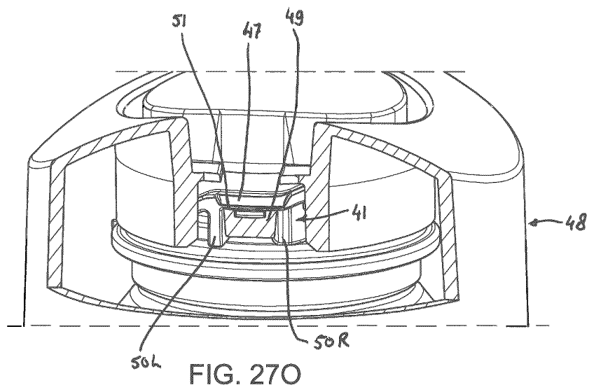

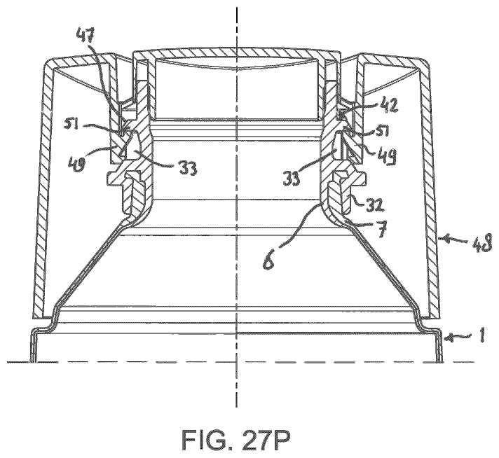

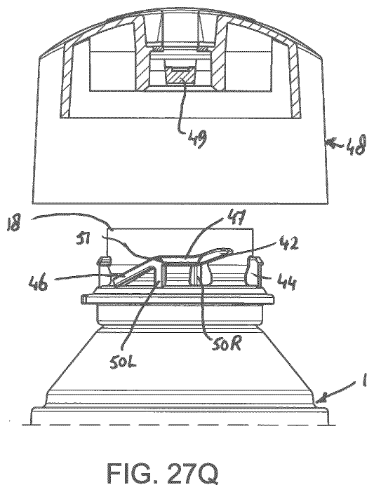

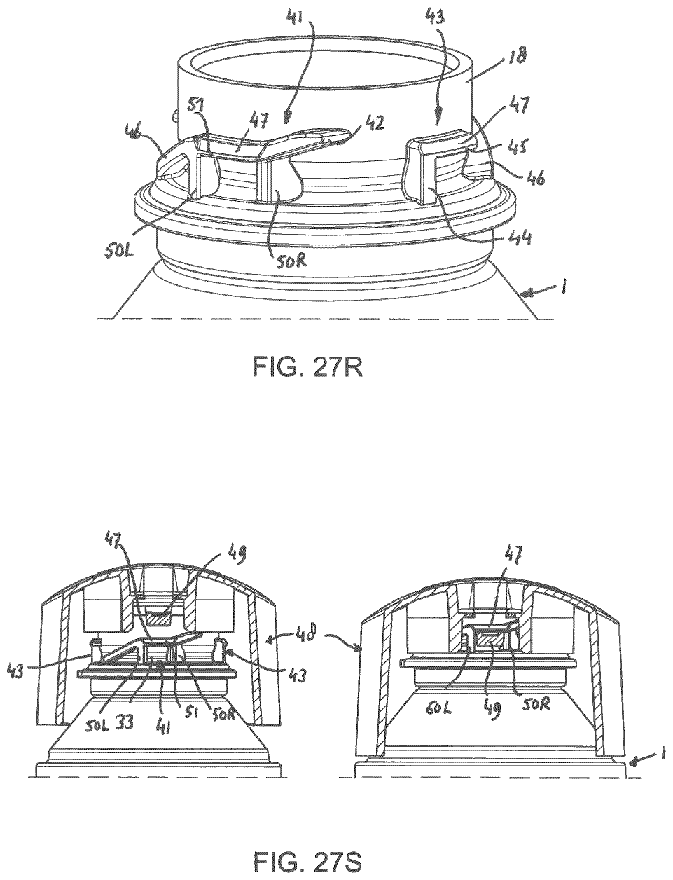

FIG. 15 depicts an exemplary pre-form 2 with a bayonet neck finish according to exemplary embodiments of the present invention. Bayonet type closures use horizontal lugs mating with horizontal recesses 33, which facilitates turning the dispenser cap for removal. These are described more fully below, in connection with FIGS. 27A through 27U.

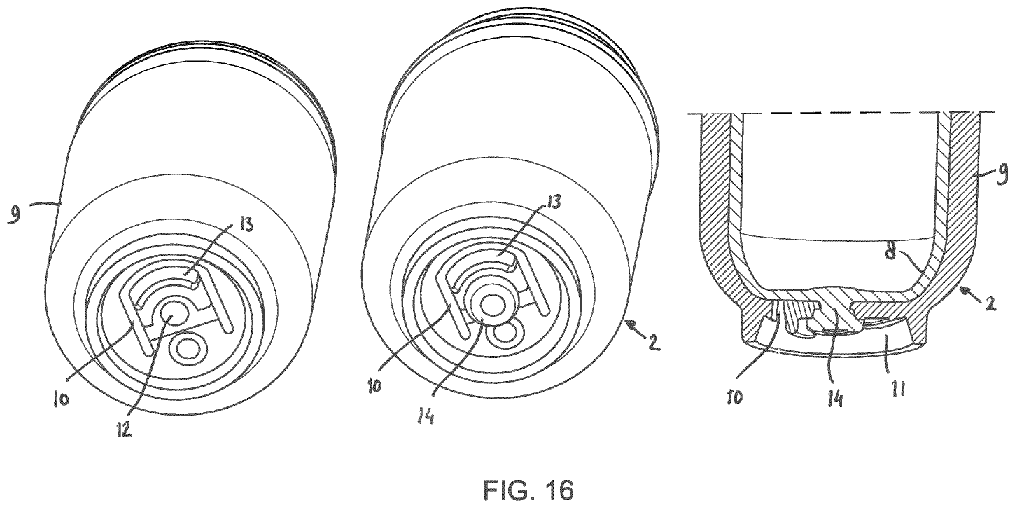

FIG. 16 depicts a 2C molded pre-form 2 with the familiar pressure releasing device (“pusher”) 13 built into the outer layer 9, as described above in connection with FIG. 3. FIG. 17 depicts an exemplary PET/PP pre-form 2 with a crimp neck finish 59, labelled and shown in FIG. 18, according to exemplary embodiments of the present invention, and FIG. 18 depicts various views of an exemplary pre-form with the crimp neck 59, with a valve 60, an air valve 24 and a dip tube 37 according to exemplary embodiments of the present invention.

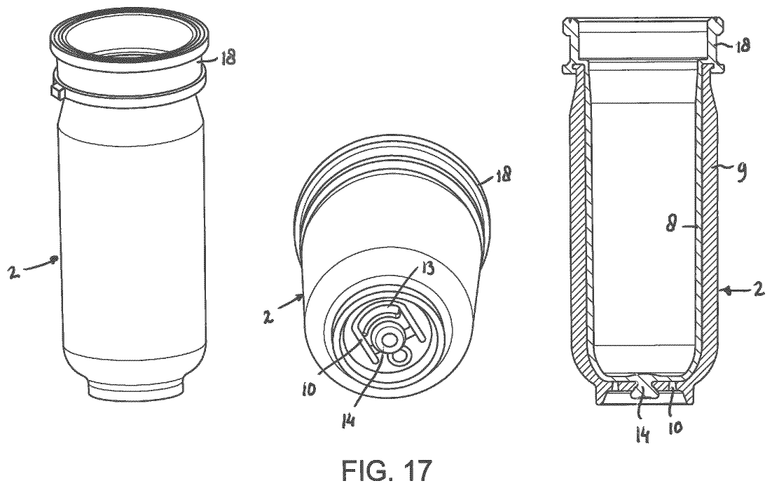

FIG. 19 depicts how an exemplary pre-form 2 can be blown into various bottle types, with exemplary dimensions provided for illustration. Exemplary pre-forms according to exemplary embodiments of the present invention can be blown to various shapes and sizes of full-size bottles or containers. For example, the bottle bottom can be flat or round. In the illustrated example, a flat or “champagne” type bottle bottom 4 has a width of 55 mm, a corner radius of curvature R4 of 4 mm, and the bottom of the bottle 1 protrudes vertically 2 mm below the level of the base of the preform 2, as shown.

### Piston Hair 2C PET/PET Preforms—Outer Layer First

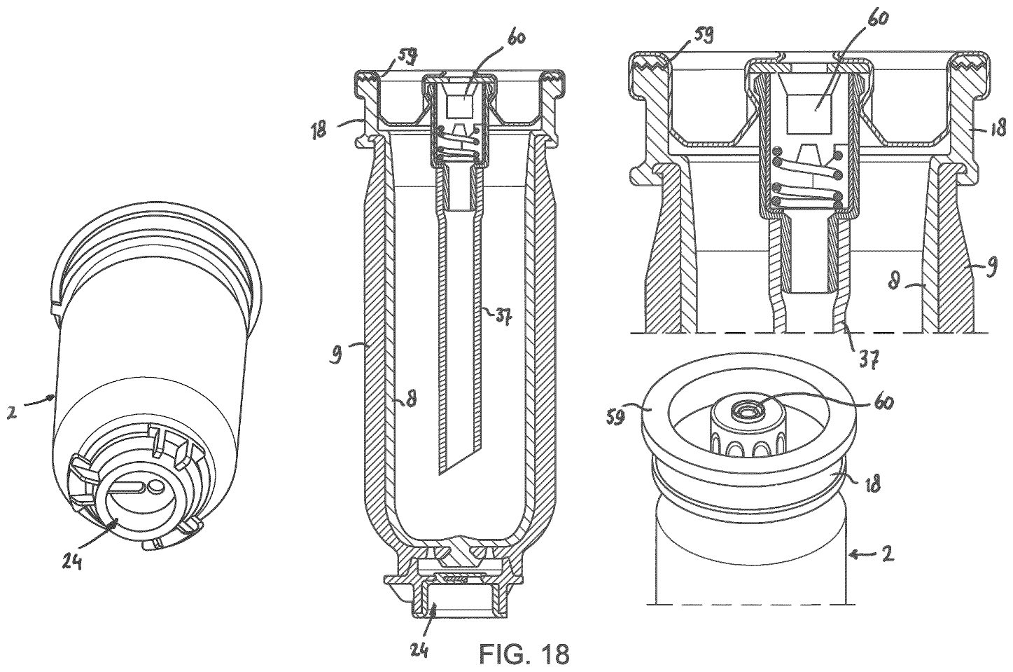

FIGS. 20-22 depict an exemplary process for 2C molding a “Piston Flair” type PET/PET pre-form 2 according to exemplary embodiments of the present invention. A Piston Flair system utilizes bonding between the inner and outer performs at the upper portion of the pre-form and thus the finished bottle. Thus, as noted above, as the displacing medium enters between the layers, the inner layer is pushed up towards the dispensing head, and folds on itself so as to move upwards along the walls of the outer container, much like a piston. The Piston Hair system is described in U.S. Published Patent Application No. US 2011/0024450, the disclosure of which is hereby incorporated herein by reference. Thus, non-stick coating 34 shown in FIG. 21 is only wanted for the bottom portion of a “Piston Flair” pre-form, inasmuch as the upper portion is desired to bond together so as to achieve this “folding on itself” piston effect.

In this example of FIGS. 20-22 the outer pre-form 9 is molded first, and a non-stick coating 34 only applied on the bottom portion of the inner/outer interface. Then the inner pre-form 8 (FIG. 22) is molded, with the end result as shown in FIG. 22, where a non-stick coating 34 has been provided between the layers, but only on the bottom portion of the pre-form 2. As noted, if one has two of the same materials, or two materials with the same molding temperature, then it can be advantageous to mold the inner preform 8 first. This has the advantage that it is easier to precisely deposit a coating on the outside of the inner preform 8 than on the inside of an outer preform 9, as shown here.

### Piston Hair 2C PET/PET Preforms—Inner Layer First

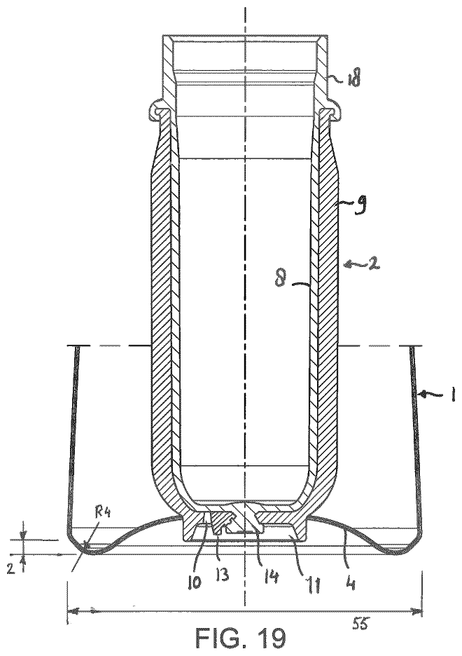

Thus, FIGS. 23-25 depict an alternate exemplary process for 2C molding a “Piston Flair Bayonet” type PET/PET pre-form 2 (FIG. 25) according to exemplary embodiments of the present invention. Here the inner pre-form 8 is molded first, as shown in FIG. 23, and then, as shown in FIG. 24, a non-stick coating 34 is sprayed on the outside of the inner pre-form 8. The result, as shown in FIG. 25, is the same as the example of FIGS. 20-22, but the spraying of the non-stick coating 34 on the outside of the inner pre-form 8 is often preferred, inasmuch as it is easier to precisely deposit the non-stick coating 34 on the outside of an inner pre-form 8 than it is to deposit it on the inside of an outer preform 9, as shown in FIG. 21, due to the freedom of movement of the spraying device/robot in the former case.

Preform with One Way Valve

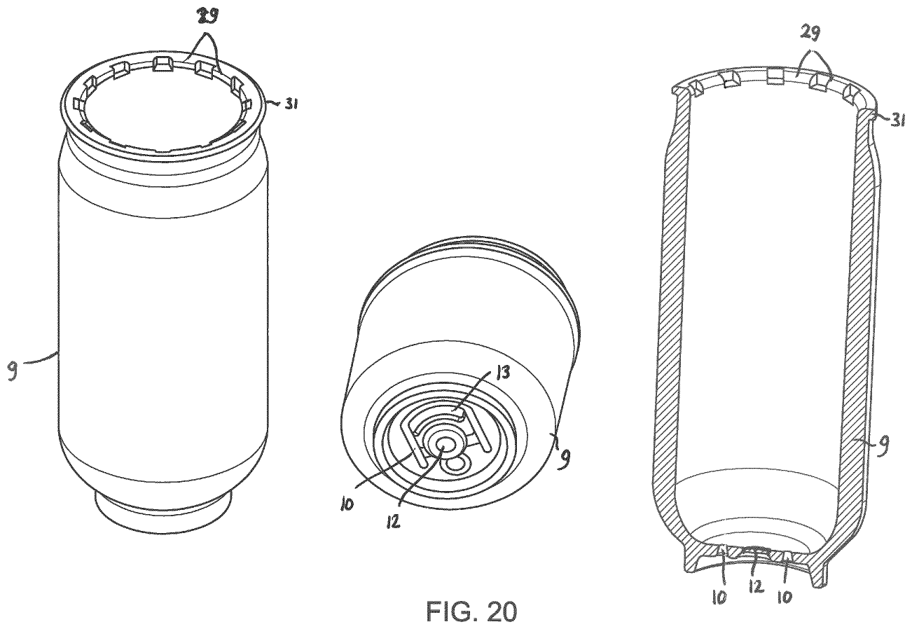

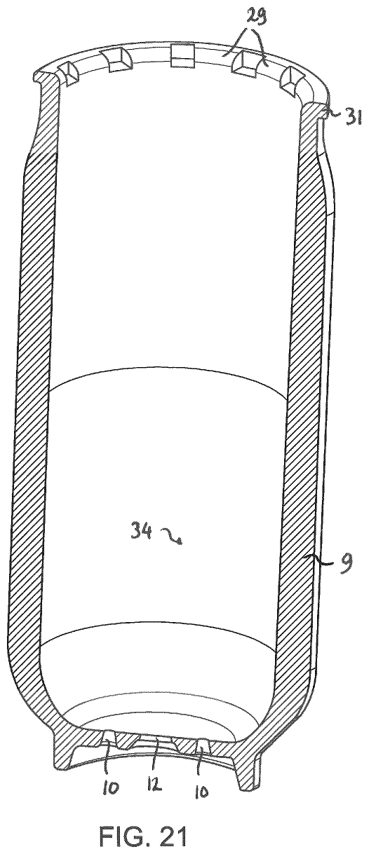

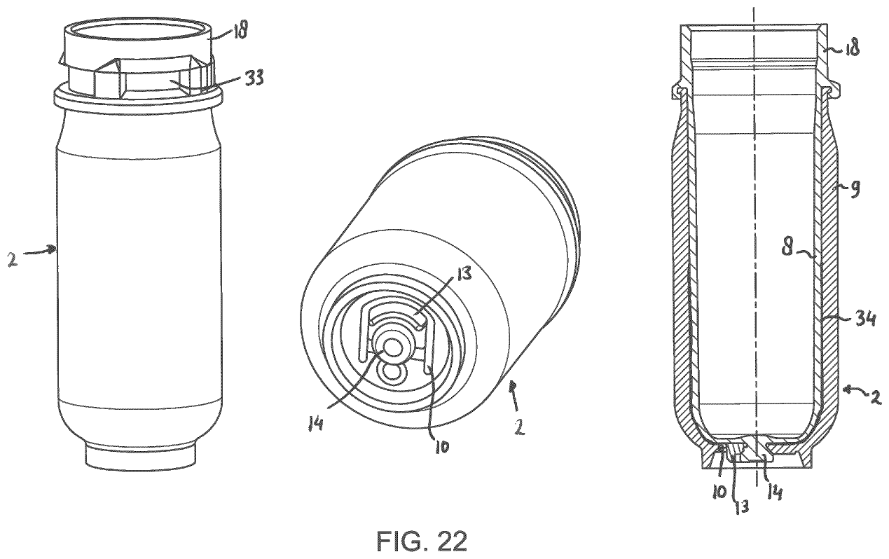

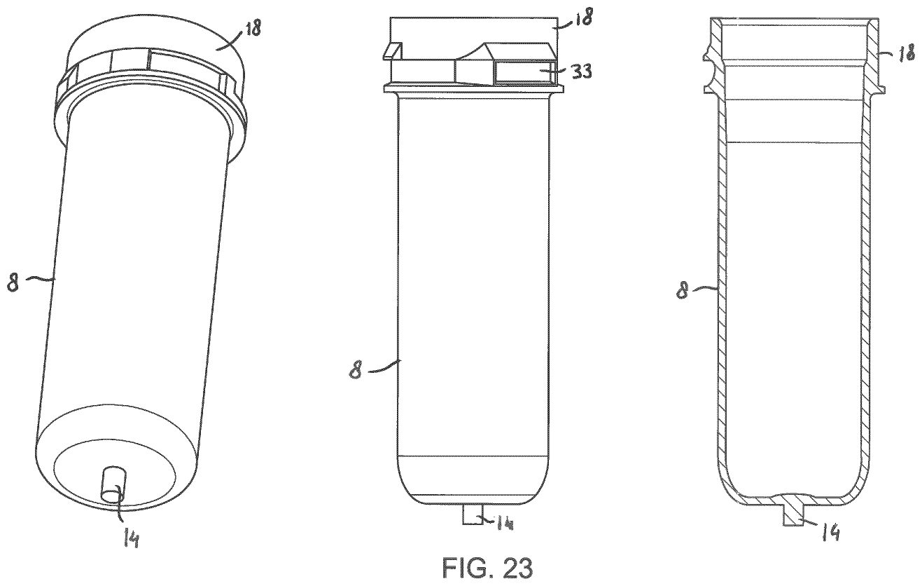

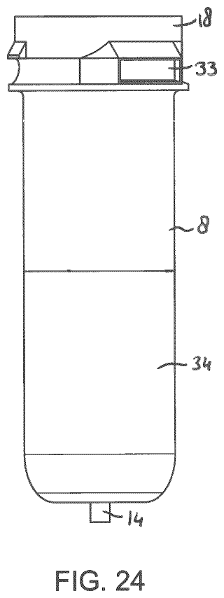

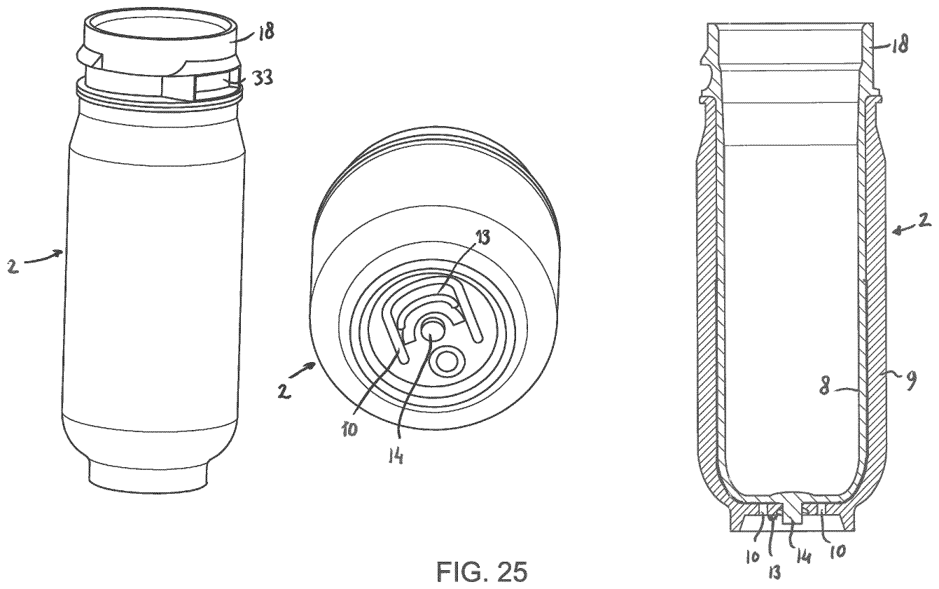

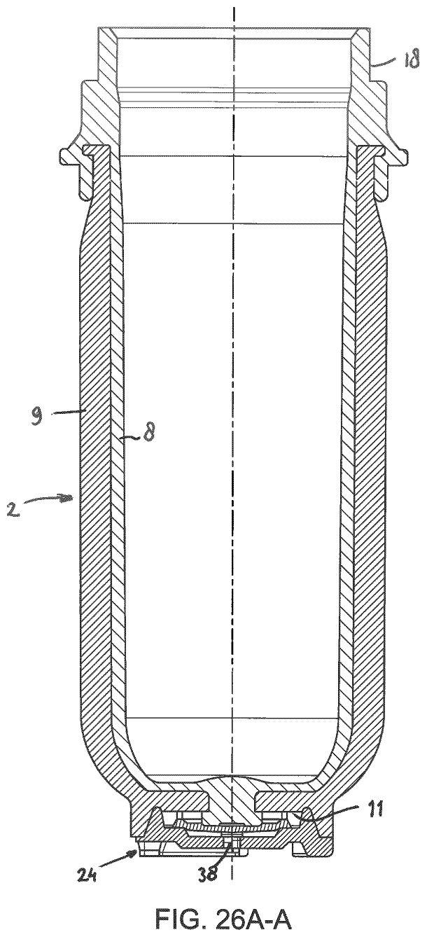

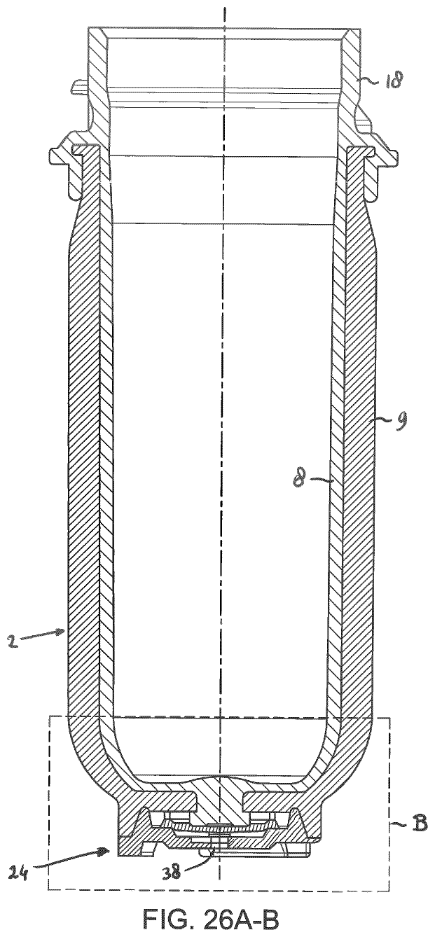

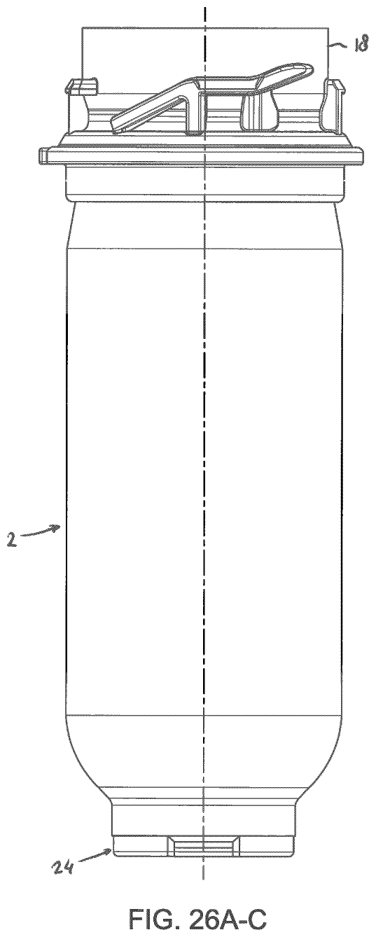

FIGS. 26A through 26H illustrate an exemplary preform 2 with a one-way valve 24 according to exemplary embodiments of the present invention. With reference to FIG. 26A-A, a cross section of the preform 2 with valve 24 attached is shown and the same figure is replicated in FIG. 26A-B with an area of detail indicated—Detail B—which will be presented in the following figures. FIGS. 26A-C and 26A-D show side-views with the preform 2 standing vertically upright and upside down, so as to show the bottom 24. Similarly, FIG. 26A-E shows a close-up bottom view with two lines A-A and B-B through which cross sections will be presented.

FIG. 26B is the magnification of the Detail B region indicated in FIG. 26A-B. It illustrates that to avoid refilling of the bottle after use it is possible to provide the preform 2 with a one-way valve 24. Such a valve can be, for example, a loose plate of flexible plastic, such as, for example, an elastomeric disc 26, TP, or PE caught in a PET valve seat 25 which can be connected to the preform 2 for example by spin welding.

FIGS. 26C through 26E illustrate the function of this one way valve 24. As seen with reference to FIG. 26C, when there is an under pressure in the bottle 1 the two layers 6 and 7 separate (being the inner container and outer container, corresponding to the inner and outer layers 8, 9 of the preform 2, as described above) and air can flow in from the ambient air at the bottom through the one way valve 24 to allow the Flair system to operate (displacement medium between two containers), as shown by the arrow at the bottom right of the figure. As also shown, once the layer 6 is pulled upwards, it moves to position 6′, above the air gap.

FIG. 26D shows what happens when the inverse occurs, i.e. when there is an overpressure in the bottle 1. Here the air between the layers 6′, 7 tries to flow back out through the bottom 4 (as shown by the arrow at the bottom ending at the disc 26) but the one way valve 24 blocks the air flow. These principles can be used for a “Squeeze Flair” type of system, where a user squeezes on the outer container 7 to dispense a liquid from the inner container 6, and as that occurs the underpressure between the containers 6, 7 sucks in air through the one way valve 24. However, the one way valve 24 lets air in, but does not allow it to escape, thus maintaining the pressure on the inner container 6 for dispensing. Additionally, as shown in FIG. 26E, such a one way valve 24 provides an anti-refilling functionality. When the bottle 1 is empty and a consumer tries to refill the bottle, for example, he finds it to be impossible to do inasmuch as when the inner container 6 is refilled (from the top, for example) the air between the layers 6 and 7 tries to flow back through the one way valve 24 at the bottom but the one way valve 24 blocks the air flow. Moreover, the central hole 38 in the valve housing 25 is so small that it is impossible to force the valve 24 open by even a small pin. Even when pushing a small pin in the center, for example, the valve 24 will block the flow of air outwards, unless a user actually punctures the disc 26, which renders the device unusable in any event. This makes it impossible to refill the bottle 1 inasmuch as the pressure between the layers 6, 7 maintains the inner layer 6 in a shrunken position 6′, i.e. the one it had as it dispensed the last portion of the fluid or liquid that was in. Thus, try as they might, a consumer cannot refill the bottle 1. This necessitates purchasing a replacement bottle and of course generating a fee for the seller, as well as insuring quality control and preventing refilling and resale by unauthorized merchants.

FIG. 26F illustrates how a one way valve 24 with a layer separation/release button 15, as described above in connection with FIGS. 3, operates. When a layer separation/release button 15 is used (such as when layer release is not accomplished with a coating), a one way valve 24 cannot be connected to the preform 2 prior to blowing the preform into the bottle, due to the protruding pin 15 which is used in layer separation after blowing. Rather, the one-way valve 24 has to be spin welded onto the bottle after the layers have been separated by an over-pressure, as described above and illustrated with reference to FIG. 3. Accordingly, with reference to FIG. 26G, after blowing the preform 2 into a bottle 1 the manufacturer must first push in the layer separation button 15 (it has already performed its function) and then subsequently, as shown in FIG. 26H, attach the one-way valve 24 to the now blown bottle 1 by spin welding.

### Exemplary Snap-On Neck

FIGS. 27A through 27C illustrate a 3-lug snap-on neck finish for the inner container 8 of the exemplary preform 2 according to exemplary embodiments of the present invention. The three lug bayonet finish allows a shroud to be fixed to the top of the inner container, which can have a dispensing head or a sprayer head, as the case may be. Index numbers shown in FIG. 27A are explained with reference to FIGS. 27B and 27C, next provided. FIG. 27B similarly shows the view from a different angle of the three lug bayonet finish and FIG. 27C illustrates how the three lugs 39, 40 are not symmetric around the perimeter of the neck 18 but rather are provided in asymmetric constellation. As shown in FIG. 27C, which is a top view of the snap-on neck finish of FIGS. 27A and 27B, it can be easily seen that there are two lugs 39 having approximately 90 degrees between them and then each of them has approximately 135 degrees between their center and the center of the third lug 40 which is shown at the far left of FIG. 27C. The 3-lug configuration of sprayer heads has been described in U.S. published patent application US 2010/0018999, under common assignment herewith.

In FIGS. 27A and B, a 3-lug bayonet/snap-on neck finish on the preforms 2 and bottles 1 is shown. The 3-lug version has only ONE position (orientation) which is correct, i.e., in which a cover or dispensing head can be fitted on it. It is noted that in combination with flat bottles, such as sprayers, with a defined front portion (nozzle) and a rear portion, this is often useful, as it is easy to properly orient a flat type bottle on a filling line so that this unique orientation is assumed prior to filling and attaching of the shroud. The ONE position is there for the reason that the three lugs 39, 40 are not, as noted above, equally spaced around the perimeter of the neck, as in (3×120°), but are rather spaced with 1350-90°-135° subtended angles, as noted in U.S. patent application Ser. No. 12/448,132, published as U.S. Patent Application Publication No. 2010/0018999, the disclosure of which is hereby fully incorporated herein by reference.

However, this can present a problem when using round bottles. In a filling line, for example, as well as after the consumer has done a refill action, the connection of the cap or device on the round bottle shroud is difficult for reason there is no easily identifiable orientation (round bottle). To avoid this problem a novel 4 lug bayonet/snap-on neck finish has been developed, as next described.

### Four (4)—Lug Bayonet Neck and Snap-on Cap

In contrast to the three lug bayonet snap-on neck finish, FIGS. 27D through 27G depict a novel 4-lug bayonet snap-on neck finish according to exemplary embodiments of the present invention. These figures use the same index numbers for the same elements, for ease of reference between them. FIG. 27D shows a front perspective view of such an exemplary bottle 1 with such an exemplary four lug bayonet snap-on neck finish, and FIG. 27E illustrate different views of the same bottle 1, the top image looking head on into a lug 41 with a lead-in structure 42 and the bottom image showing a standard lug 43 (vertical rib 44 on right and horizontal bar 45 connected to it). With reference to FIG. 27D, the 4-Lug version bottle finish has four bayonet/snap-on lugs 41, 43. Two of the lugs are provided with lead-in and lead-out guidance ribs 42, 46 (this type of lug 41 is shown in the top image of FIG. 27E). In exemplary embodiments of the present invention, two out of four lugs being equipped with the lead-in and lead-out sloping structures 42, 44 are sufficiently functional, as well as appropriate for molding reasons, inasmuch as to make four lugs with lead-in/lead-out ribs is not possible with two slides in a mold. It would require four slides and increase complexity, but can be done, for example, if special reasons make it the best choice. Moreover, also as shown in FIG. 27D, in the upper, for example, 4 mm of the bottle finish, no ribs are allowed; otherwise there would occur sink marks at the inner sealing surface, and in order to obtain a tight seal, a cap needs some vertical “lead in” space so that the top of the cover fits snugly on the top of the neck 18.

FIG. 27F shows a top view of the snap-on neck finish where it can easily be seen that there are four lugs 41, 43, of two different types, provided symmetrically with 90 degrees between their centers around the parameter of the bottle neck 18. The lugs 41 at the top and bottom of the upper image of the figure have the lead-in and lead-out structures 42, 46, and the ones at 3 and 9 o'clock (right and left) in that upper image have just the plain lugs 43. Thus, one can exploit this symmetry and need not necessarily line up a dispensing head or a sprayer head or similar cap in any particular one orientation relative to the neck 18, as was required with the 3-lug system described above. FIG. 27G shows that a lead in 47 for a snap-on hook 49 and snap-on upper cap 48 (no rotation, just pushing downwards) is also possible, where on an assembly line, for example you line the cover or cap 48 up above the four lugs 41, 43 and simply push down, the hooks 49 on the cover 48 each gliding down the sloped lead-in 47 to hook into the slot 33 on the lug (under the horizontal bar 45), as opposed to using the lead-in 42 to guide in a rotational sense and lock in the lugs 41, 43 that way. However, the bottle 1 has to be lined up correctly for such a snap-on (no rotation) hook attachment method, which requires more precision and complexity.

FIGS. 27H and 27I together illustrate an exemplary cap or cover 48 arranged to mate with the four lugs on the bottle's neck 18, according to exemplary embodiments of the present invention. Such a cap 48 has four identical bayonet type snap-on hooks 49 to mate with the four lug bayonets 41, 43 of the neck 18, as shown in FIGS. 27D through 27G. With reference to FIGS. 27H-A and 27H-C there is, respectively, a side and underside view of an exemplary snap-on cap 48 and in each of these views is drawn a line through which a cross section will be presented. The cross section through line A-A in FIG. 27H-B shows that the cap 48 has four identical bayonet snap-on hooks 49, and similarly, the cross section through line B-B, shown in FIG. 27H-D illustrates what it looks like when a slice is cut between any two lugs, essentially bisecting the 90 degree angle between them. Similarly, FIG. 27I together show perspective drawings of the four lug bayonet snap-on cap 48. FIG. 27J shows the principle of attaching the four lug bayonet cap 48 of FIGS. 27H and 27I onto a Flair type bottle provided with a four lug bayonet neck finish, as described above. As can be seen with reference to FIG. 27J, which shows cut-away views of such an exemplary cap 48, the cap 48 can be attached to the neck 18 from any of four equivalent positions simply by making a vertical downwards(V) and a radial (R) movement. The vertical movement V pushes the cap 48 in line such that each of the hook bayonet snap-on hooks 49 are set somewhere between two adjacent lugs 41, 43—which are spaced apart the width W of a bayonet hook 49—and a twisting or radial movement R locks each of them into its corresponding lug 41, 43. The hooks 49 attach under the vertical bar of each lug, after being guided downwards to the proper vertical level by the lead-in structures 42 of the two embellished ribs. Because of the symmetry, as shown in FIG. 27F, there are actually four orientations with which a cap 48 can be initially placed in assembly, all of which will result in the same result of the four lug bayonet cap 48 being properly attached with each hook 49 in the cap 48 mated to a corresponding lug 41, 43 on the neck 18. FIGS. 27K, 27L and 27 M are simply respective magnified views of each of the images FIGS. 27J-A, 27J-B and 27J-C for ease of inspection.

FIG. 27N together illustrates an exemplary cap 48 attaching to a neck 18. Here in FIG. 27N-A a hook 49 of the cap 48 is guided leftwards by the underside of a lead-in structure 42, and in FIG. 27N-B it has attached between the two vertical ribs 50 of this embellished lug 41. FIG. 27O illustrates features of the “end rib” 50L on each lug (left side of the lug 41 in each figure) and the “anti back off rib” (right side of an embellished lug 41) on two of the lugs (the ones with the lead-in structures 42, as shown in FIG. 27E, for example). The end rib 50L prevents a cap 48 from turning too far, and the anti back off rib 50R creates a certain minimum amount of force needed to remove the cap 48. To remove the cap 48, i.e., rotate it the counter-clockwise direction, the hook 49 has to push over and across the anti back off rib 50R, which requires some force to accomplish. As can be seen, the end rib 50L protrudes farther outward radially than the anti back off rib 50R, and thus a user cannot turn further clockwise past this barrier. FIG. 27P, showing a cross section through two lugs 41, 43 and hooks 49 (spaced 180 degrees apart) of a cap 48 attached to a neck 18, illustrates the four lug bayonet cap 48 principle as described above, showing the interlocking of the hooks 49 of the cap 48 with the lugs 41, 43 of the neck 18, nicely positioned under the horizontal bar 45, 51 of each lug 41, 43. It is also noted that the depicted neck 18 has the overmolded feature of inner container 6 over outer container 7, as shown in FIG. 7B above. FIGS. 27Q, R and S illustrate further details of the snap-on principle. FIG. 27Q shows in its upper panel how if one lines up the cap 48, four identical positions are possible (between lugs 41, 43 at any relative orientation of cap 48 and bottle neck 18). FIG. 27R shows how the vertically sloping horizontal portions 47 of the lugs 41, 43 can be used as vertical lead-in structures for a pure snapping on attachment (no turning), but in this case one must line up the cap 48 so that the four hooks 49 are right over the four lugs 41, 43. Finally, FIG. 27T illustrates an exemplary cap 48 and bottle neck 18 where snap-on has been completed. When a consumer removes the cap 48 by turning it counter clockwise, the cap 48 can be replaced according the bayonet principle, as illustrated above i.e., can be removed and replaced repeatedly.

FIG. 27U illustrates the case where the cap 48 is desired to be irrevocably attached, so that a user may not remove it and refill the contents on his or her own. To create an non removable snap-on connection between bottle 1 and device 5 (see FIGS. 1 and 2, as described above), the two anti-back-off ribs 50R of the normal snap-on embodiment of FIGS. 27S and 27T (said anti back off ribs 50R being provided on the two lugs 41 with lead-in structures 42) have to be increased in diameter (i.e., in their radial outward protrusion), to equal the radial outward protrusion of the end ribs 50L such that when the snap-on hook 49 of the device is locked in place in between the ribs 50L, 50R it is not possible to further turn the device the other way to remove it (one can never turn further clockwise to push past the end ribs 50L; the non removable snap-on connection simply extends this feature to the anti back off rib 50R as well).

### Matching Pre-Form Heating Profiles for Blowing

As noted above, in various exemplary embodiments of the present invention, a preform 2 is often made using different materials for the inner container 8 and the outer container 9. This presents a technical problem however, in that different materials, say, for example, PET and PP, have different optimal blowing temperature ranges for accomplishing that blowing. As described above, after being molded, a preform 2 is then blown to its final shape to be used in a Flair type bottle 1. Thus, both the inner perform 8 and the outer perform 9 are blown together. In order to accomplish the blowing process such that both layers 8, 9, inner and outer, blow out completely to their final shape, the blowing temperatures of both layers need to be closely matched.

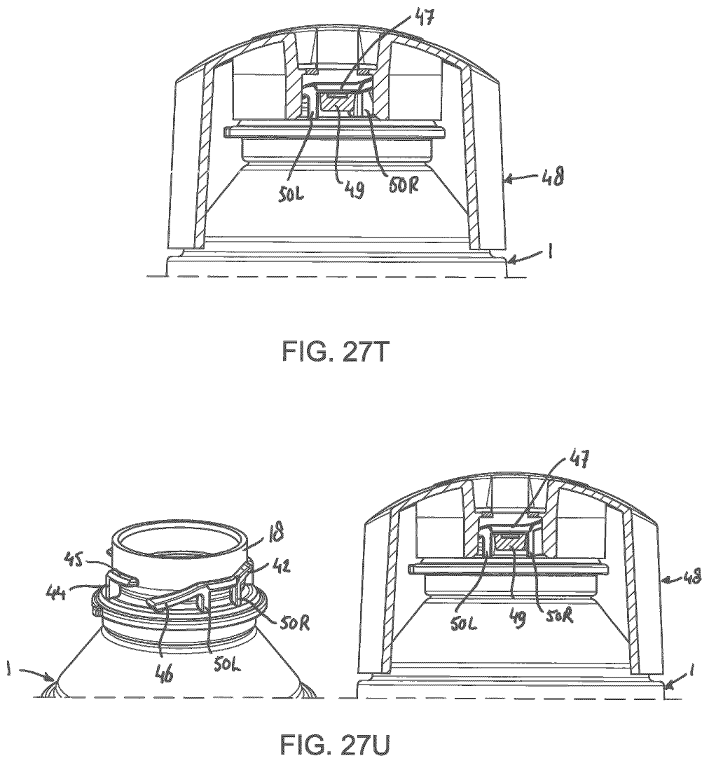

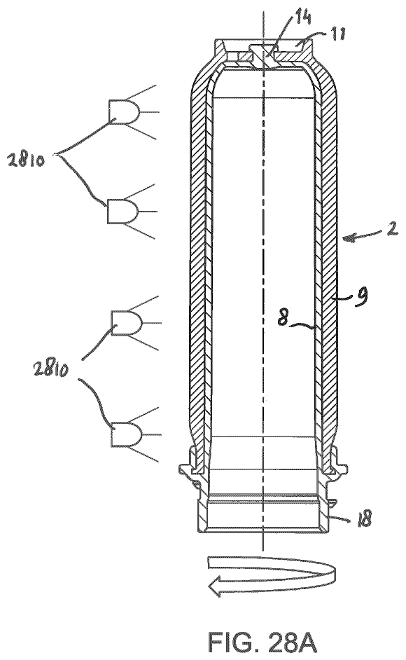

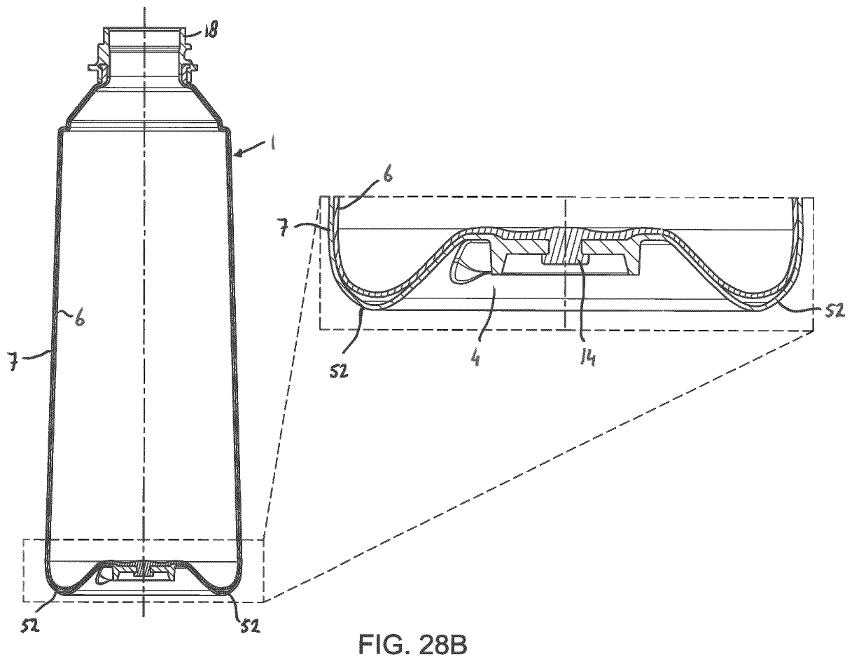

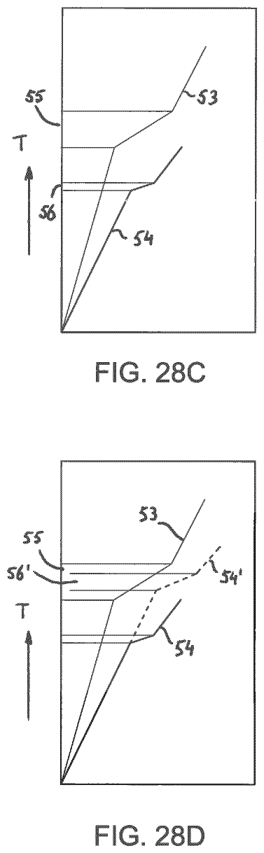

FIG. 28 illustrate details of this process and the proper matching of the materials of an exemplary inner container and outer container. With reference to FIG. 28A, an exemplary preform 2 is shown, rotating inside a heating oven so that it can be made ready to be blown into a bottle. The exemplary preform has an outer layer 9 of Material ‘A’, PET for example, and an inner layer 8 of Material ‘B’, polypropylene, for example. In general, each material type has its own optimal blowing temperature, which is a function of tis plasticization and heat transfer profile. As shown in FIG. 28A, the heat for the inside layer 8 has to come through the outside layer 9, inasmuch as the preform 2 is placed inside a heating oven. Thus, as shown, heating elements 2810 are on the outside of the outer container 9. Thus, to get the optimal blowing temperature for the outside layer 9 one can adjust the intensity of the heating elements 2810 and the speed of heat transfer of the heating oven, but this optimum adjustment for the outside layer 9 does not in general give the optimum blowing temperature for the inside layer 8, especially when the inside layer 8 is made of an other material type than the outside layer 9.

FIG. 28B illustrates the reason why it is so crucial to optimize the blowing temperatures of the inside and outside layers. FIG. 28B depicts a fully blown bottle 1 (right image), and a detail of the bottom corners 52 (left image), for an exemplary preform such as that shown in FIGS. 7A, above. To blow the bottle 1 in the given shape, both of the layers 6, 7 have to blow out completely. If the internal layer 6 cannot completely stretch to the shape of the outer corner 52, the outer layer 7 will also not reach its intended shape for the reason that the bottle 1 is blown out from the inside. This phenomenon will happen if the temperature of the inner layer 6 is too low. On the other hand, if the temperature of the inside layer 6 is too high, then both layers 6, 7 can assume the desired shape, but the cycle time of the blowing process increases significantly. As a result, the inner layer 6 has to be cooled down enough so that it does not pull back by reason of shrinkage. A temperature that is too high can also easily cause other blowing failures.

Finally, FIG. 28C depicts a comparison of ideal blowing temperatures for two exemplary materials used, respectively, as the outer layer 9 and inner layer 8 of a preform 2. Their respective plastification and heat transfer profiles 53, 54 are plotted with varying temperature (T). Here the outer layer 9 is Material ‘A’ shown in plot 53, and the inner layer 8 is Material ‘B’ shown in plot 54. As can be seen from the graph of FIG. 28C, Material A has a broader ideal temperature range 55 for blowing, (even though it has a greater slope). Material B has a rather narrow ideal temperature range 56, and thus a correspondingly narrow interval during which it is within this range. The two materials do not overlap as to plastification regions, and thus as to ideal blowing temperatures. To remedy this situation, the curves need to be aligned.

By using different colors and or additives in the outer and/or inner layer, it is possible to get the optimal plastification profiles, for blowing an exemplary preform assembly 8, 9 that is made out of two different materials. For example, adding a black or brown pigment to Material ‘B’ and a white one to Material ‘A’ will cause less heat absorption by the latter, and more by the former. Other additives can also affect the plastification temperature ranges and the heat transfer properties. This can also be done, alternatively, by using a coating between the two layers, via surface treatment by nanotechnology, and/or by change the molecular structure using nanotechnology. FIG. 28D depicts such a modification (shown by dashed line 54′), where Material ‘B’ has now been changed, and its plot is now shown as 54′, so that its plastification region 56′ (and thus its optimal range of blowing temperatures) now lies within the plastification region 55 (and thus optimal range of blowing temperatures) of Material ‘A’, discussed above.

For example, PET has a higher plastificaiton temperature than PP and other polyolefins. Thus, for blowing a preform 2 made out of a PET outer layer 9 and a PP (polypropylene) inner layer 8, there can be a significant mismatch. However, by adding a black or brown color tot he PP and a white color to the PET, given that brow/black absorbs approximately 70% more heat than white, one can broaden and raise the temperature range of PP, and lower that of PET, such that there will be a temperature interval, as shown in FIG. 28D, within which both layers 8, 9 can optimally be blown. Of course, one wants to set the blowing temperature at the center of the available temperature interval, so that given a Gaussian distribution curve, for example, or preforms and/or areas within them, as many preforms 2 as possible will lie fully within the range, and blowing will be successful.

Thus, in exemplary embodiments of the present invention, in order to get a wide process window during the blowing process the plastification curves of the preform layers 8, 9 which can be made out of different materials, can be changed. Once such change is effected, a multi-layer preform 2 can be blown as if it were composed of one material.

It is further noted that in various exemplary embodiments, there can be three or even more layers to a preform 2. In such case, all three layers, or all N, for an N layer preform, need to be adjusted such that there is a range of blowing temperatures which is common to all three, or all N, as the case may be, materials that comprise the various layers.

The above-presented description and figures are intended by way of example only and neither are intended to limit the present invention in any way except as set forth in the following claims. It is particularly noted that persons skilled in the art can readily combine the various technical aspects of the various exemplary embodiments described.

What is claimed is:

1. A preform for a liquid dispensing device, comprising:
an inner layer; and
an outer layer,
wherein the inner and outer layers are sealably connected at both a bottom portion and a top portion of the pre-form, and
wherein the outer layer is provided with an integrally molded pressure releasing mechanism such that when pressed, any pressure between the inner and the outer containers is released.

2. The preform of claim 1, wherein the inner layer and the outer layers are made of either the same material, or different materials.

3. The preform of claim 2, wherein one of:
both the inner and outer layers are made of PET;
one layer is made of PET and the other is made of a polyolefin; and
the inner layer is made of a polyolefin and the outer layer is made of PET.

4. The preform of claim 1, wherein the inner layer and the outer layer are made by bi-injection molding.

5. The preform of claim 4, wherein if the two layers are of the same material, or have substantially the same molding temperature, a non-stick coating is applied to at least a portion of the first layer to be molded prior to molding the other layer.

6. The preform of claim 5, wherein if the outer preform is molded first then the non-stick coating is applied to the inside of the outer layer, and if the inner pre-form is molded first then the non-stick coating is applied to the outside of the inner layer.

7. The preform of claim 4, wherein the inner layer and the outer layer are joined at the neck and at the bottom at the completion of the bi-injection molding process.

8. The preform of claim 4, wherein the outer layer is molded first, a hole is left in the center of the bottom of the outer layer, and the inner layer is molded by injection into said hole.

9. The preform of claim 5, wherein the outer layer is molded first, a hole is left in the center of the bottom of the outer layer, and the inner layer is molded by injection into said hole.

10. The preform of claim 4, wherein the inner layer is molded first, a hole is left in the bottom of the inner layer, and the outer layer is over molded onto the inner container.

11. The preform of claim 10, wherein the hole in the bottom of the inner layer is filled by a vertical protrusion from the inside bottom of the outer layer, thus joining the two containers.

12. The preform of claim 4, wherein the inner layer is made from one of a polyolefin and a polyamide.

13. The preform of claim 4, wherein the inner layer is arranged to shrink a defined percentage relative to the outer layer.

14. The preform of claim 13, wherein the material from which the inner layer is made, the degree of shrinkage it will experience relative to the outer layer, and the concomitant hot fill maximum temperature it can thus support, are designed for a given application, use or range of uses.

15. A method of blowing a preform having an outer layer made from a first material and an inner layer made from a second material into a bottle, comprising:
determining the optimal blowing temperature range for the first material;
determining the optimal blowing temperature range for the second material; and
if the respective blowing temperature ranges do not overlap:
adjusting one or both materials so that there is an overlap between the two respective optimal blowing temperature ranges; and
setting a blowing temperature for the preform to be at the center of the narrower of the two ranges, as adjusted.

16. The method of claim 15, further comprising making the inner layer and the outer layer by bi-injection molding, wherein the inner layer and the outer layer are joined at the neck and at the bottom at the completion of the bi-injection molding process.

17. The method of claim 16, further comprising:
if the two layers are of the same material, or have substantially the same molding temperature, applying a non-stick coating to at least a portion of the first layer to be molded prior to molding the other layer.

18. The method of claim 16, further comprising either:
first molding the outer layer, leaving a hole in the center of the bottom of the outer layer, and molding the inner layer by injection into said hole; or
first molding the inner layer, leaving a hole is in the bottom of the inner layer, and overmolding the outer layer onto the inner layer.

19. The method of claim 15, wherein the inner layer is made from one of a polyolefin and a polyamide.

20. The method of claim 15, wherein the inner layer is arranged to shrink a defined percentage relative to the outer layer.
